(19) United States
(12) Patent Application Publication
(10) Pub. No.: US 2026/0245007 A1
(43) Pub. Date: Aug. 20, 2026

(54) INTELLIGENT DISPATCHING METHODS, SYSTEMS AND NON-TRANSITORY COMPUTER-READABLE STORAGE MEDIUMS

(71) Applicant: YIZHI TECHNOLOGY (CHENGDU) CO., LTD., Chengdu (CN)

(72) Inventors: Yi ZHAO, Chengdu (CN); Xiyong JIANG, Chengdu (CN); Lanxi YU, Chengdu (CN)

(73) Assignee: YIZHI TECHNOLOGY (CHENGDU) CO., LTD., Chengdu (CN)

(21) Appl. No.: 19/640,518

(22) Filed: Apr. 7, 2026

Related U.S. Application Data
(63) Continuation-in-part of application No. PCT/CN2024/126142, filed on Oct. 21, 2024.

(30) Foreign Application Priority Data
Oct. 20, 2023 (CN) 202311365182.8

(51) Int. Cl. G06Q 10/0631; G06Q 10/10; G06Q 50/08

(52) U.S. Cl. CPC G06Q 10/063112; G06Q 10/103; G06Q 50/08

(57) ABSTRACT

An intelligent dispatching method, system, and storage medium are provided. The method is performed by an intelligent dispatching system, the intelligent dispatching system is deployed on a construction management server, and the method comprises: obtaining a mapping relationship between a construction task and a construction skill from the construction management server; obtaining historical construction task information of one or more workers in a construction organization from the construction management server, and obtaining construction skills of the one or more workers from one or more worker terminals of the one or more workers; determining a quantitative parameter of a corresponding construction skill based on the historical construction task information; obtaining a construction task to be assigned in a construction project from the construction management server, and determining at least one target worker from the one or more workers based on the mapping relationship, according to the construction task to be assigned and the quantitative parameter of the construction skill; and dispatching the construction task to at least one target worker terminal of the at least one target worker.

### CROSS-REFERENCE TO RELATED APPLICATIONS

This application is a Continuation-in-part of International Application No. PCT/CN2024/126142, filed on Oct. 21, 2024, which claims priority to Chinese Patent Application No. 202311365182.8, filed on Oct. 20, 2023, the entire contents of each of which are hereby incorporated by reference.

### TECHNICAL FIELD

The present disclosure generally relates to the field of computer information technology, and in particular to an intelligent dispatching method, system, and non-transitory computer-readable storage medium.

### BACKGROUND

A construction project includes a plurality of different construction tasks, and each construction task requires workers with different construction skills to complete. However, workers in the construction organization have different construction skills with varying levels of proficiency, the scheduling of workers availability is complex, and the efficiency and compensation for different construction skills of different workers are also different. In addition, based on different dispatching objectives (e.g., the shortest construction period, the lowest cost), the dispatching modes for different construction tasks are also different. Consequently, the dispatching efficiency for construction tasks is low, and it is difficult to balance the requirements for construction period, cost, and quality.

Therefore, it is necessary to provide an intelligent dispatching method that can intelligently dispatch workers in the construction organization, thereby improving dispatching efficiency while balancing the requirements for construction period, cost, and quality of construction tasks.

### SUMMARY

One or more embodiments of the present disclosure provide an intelligent dispatching method. The method is performed by an intelligent dispatching system, wherein the system is deployed on a construction management server. The method comprises: obtaining a mapping relationship between construction tasks and construction skills from the construction management server; wherein the mapping relationship between the construction tasks and the construction skills is established by an administrator terminal and uploaded to the construction management server; obtaining historical construction task information of one or more workers in a construction organization from the construction management server, and obtaining construction skills of the one or more workers from one or more worker terminals of the one or more workers; determining quantitative parameters of the construction skills corresponding to the historical construction task information, wherein the quantitative parameters of the construction skills at least include a cost parameter, a quality parameter, and a capacity parameter; obtaining a construction task to be assigned in a construction project from the construction management server, and determining at least one target worker from the one or more workers based on the mapping relationship according to the construction task to be assigned and the quantitative parameters of the construction skills; and dispatching the construction task to be assigned to at least one target worker terminal of the at least one target worker.

One or more embodiments of the present disclosure provide an intelligent dispatching system. The system is deployed on a construction management server. The system comprises: a relationship establishing module, configured to obtain a mapping relationship between construction tasks and construction skills from the construction management server; wherein the mapping relationship between the construction tasks and the construction skills is established by an administrator terminal and uploaded to the construction management server; a skill quantification module, configured to: obtain historical construction task information of one or more workers in a construction organization from the construction management server, and obtain the construction skills of the one or more workers from one or more worker terminals of the one or more workers and determine quantitative parameters of the construction skills corresponding to the historical construction task information, wherein the quantitative parameters of the construction skills at least include a cost parameter, a quality parameter, and a capacity parameter; a task obtaining module, configured to obtain a construction task to be assigned in a construction project from the construction management server; and a task assignment module, configured to determine at least one target worker from the one or more workers based on the mapping relationship according to the construction task to be assigned and the quantitative parameters of the construction skills and dispatch the construction task to be assigned to at least one target worker terminal of the at least one target worker.

One or more embodiments of the present disclosure provide a non-transitory computer-readable storage medium. The storage medium stores computer instructions, and when a computer reads the computer instructions in the storage medium, the computer performs the intelligent dispatching method.

### BRIEF DESCRIPTION OF THE DRAWINGS

The present disclosure will be further described by way of exemplary embodiments, which will be described in detail with reference to the accompanying drawings. These embodiments are non-limiting, wherein like reference numerals designate like structures, and wherein:

FIG. 1A is a schematic diagram illustrating an exemplary application scenario of an intelligent dispatching system according to some embodiments of the present disclosure;

FIG. 1B is a schematic diagram illustrating an exemplary interaction among a construction management server, an administrator terminal, and a worker terminal according to some embodiments of the present disclosure;

FIG. 2 is a block diagram illustrating an exemplary intelligent dispatching system according to some embodiments of the present disclosure;

FIG. 3 is a flowchart illustrating an exemplary intelligent dispatching process according to some embodiments of the present disclosure;

FIG. 4 is a flowchart illustrating an exemplary process for determining quantitative parameters of construction skills of one or more workers according to some embodiments of the present disclosure;

FIG. 5 is a flowchart illustrating an exemplary process for dispatching a construction task to workers in a construction organization according to some embodiments of the present disclosure;

FIG. 6 is a schematic diagram illustrating exemplary personal skill factors of construction skills of workers according to some embodiments of the present disclosure;

FIG. 7 is a schematic diagram illustrating an exemplary worker sequence according to some embodiments of the present disclosure;

FIG. 8 is a schematic diagram illustrating an exemplary first dispatching mode according to some embodiments of the present disclosure;

FIG. 9 is a schematic diagram illustrating an exemplary second dispatching mode according to some embodiments of the present disclosure;

FIG. 10 is a schematic diagram illustrating an exemplary third dispatching mode according to some embodiments of the present disclosure;

FIG. 11 is a flowchart illustrating an exemplary process for updating quantitative parameters of construction skills according to some embodiments of the present disclosure.

### DETAILED DESCRIPTION

Technical For a clearer illustration of technical solutions of the embodiments of the present disclosure, accompanying drawings to be used in a description of the embodiments are briefly introduced below. It is apparent that accompanying drawings in the following description are merely some examples or embodiments of the present disclosure. For a person of ordinary skill in the art, the present disclosure can also be applied to other similar scenarios based on these accompanying drawings without making creative efforts. Unless otherwise apparent from the context or stated otherwise, the same reference numerals in the drawings represent the same structure or operation.

It should be understood that the terms ‘system’, ‘apparatus’, ‘unit’ and/or ‘module’ as used herein are a manner for distinguishing different components, elements, parts, portions, or assemblies at different levels. However, if other words can achieve the same purpose, the words can be replaced by other expressions.

As shown in the present disclosure and the claims, unless the context clearly indicates an exception, the terms ‘a’, ‘an’, and/or ‘the’ are not necessarily limited to the singular, but may also include the plural. Generally, the terms ‘comprising’ and ‘including’ merely indicate the inclusion of explicitly identified steps and elements, and these steps and elements do not constitute an exclusive enumeration, and a manner or a device may also include other steps or elements.

Flowcharts are used in the present disclosure to illustrate operations performed by a system according to embodiments of the present disclosure. It should be understood that preceding or subsequent operations are not necessarily performed in a precise order. Rather, the steps may be processed in reverse order or concurrently. Additionally, other operations may be added to these processes, or one or a plurality of steps may be removed from these processes.

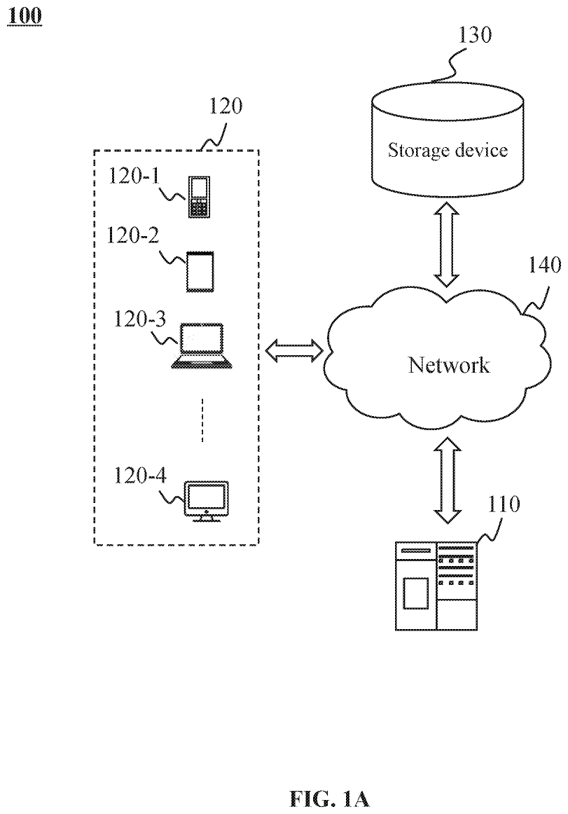

FIG. 1A is a block diagram illustrating an exemplary application scenario of an intelligent dispatching system according to some embodiments of the present disclosure. The intelligent dispatching system can, by implementing manners and/or processes disclosed in the present disclosure, improve dispatching efficiency while taking into account construction period, cost, and quality requirements of construction tasks. In some embodiments, as shown in FIG. 1A, the application scenario 100 of the intelligent dispatching system includes a processing device 110, a terminal device 120, a storage device 130, and a network 140.

The processing device 110 is configured to process data and/or information from at least one component of the application scenario 100 of the intelligent dispatching system or an external data source (e.g., a cloud data center). For example, the processing device 110 establishes a mapping relationship between construction tasks and construction skills. For example, the processing device 110 obtains construction skills and historical construction task information of one or more workers in the construction organization and determines quantitative parameters of the construction skills corresponding to historical construction task information. For example, the processing device 110 obtains a construction task to be assigned in a construction project, and based on the mapping relationship, dispatches the construction task to be assigned to the one or more workers in the construction organization according to the construction task to be assigned and the quantitative parameters of the construction skills. In some embodiments, the processing device 110 refers to any system having computing capabilities, and includes various computers, such as a server, a personal computer, or can be a computing platform composed of a plurality of computers connected in various structures. In some embodiments, the processing device 110 includes a Central Processing Unit (CPU), a Digital Signal Processor (DSP), a System on Chip (SoC), a Microcontroller Unit (MCU), a computer, a user console, etc., or any combination thereof. In some embodiments, the processing device 110 includes a single processing device or a processing device group. The processing device group is centralized or distributed. In some embodiments, the processing device 110 is local or remote. In some embodiments, the processing device 110 is implemented on a cloud platform. For example, the cloud platform includes a private cloud, a public cloud, a hybrid cloud, a community cloud, a distributed cloud, an internal cloud, a multi-layer cloud, or any combination thereof.

The terminal device 120 facilitates an interaction between a user (e.g., a recommendation subject, a recommendation object) and the application scenario 100 of the intelligent dispatching system. For example, the terminal device 120 receives a dispatching purpose, the dispatching mode, a standard skill factor of the construction skill input by the user. For example, the terminal device 120 displays a construction project proposal to the user and receives the construction task to be assigned input by the user based on the construction project proposal. In some embodiments, the terminal device 120 includes a mobile device 120-1, a tablet computer 120-2, a laptop computer 120-3, a desktop computer 120-4, other devices having input and/or output functions, or any combination thereof.

The storage device 130 is used for storing data, instructions, and/or any other information. For example, the storage device stores the mapping relationship between construction tasks and construction skills, the construction project proposal, or the like. In some embodiments, the storage device 130 includes a Random Access Memory (RAM), a Read Only Memory (ROM), a mass storage, a removable storage, a volatile read/write memory, or any combination thereof. In some embodiments, the storage device 130 is integrated or included in one or a plurality of the other components of the application scenario 100 of the intelligent dispatching system (e.g., the processing device 110, the terminal device 120).

The network 140 facilitates an exchange of information and/or data. In some embodiments, one or more components of the application scenario 100 of the intelligent dispatching system (e.g., the processing device 110, the terminal device 120) may, through the network 140, send information and/or data to the other components of the application scenario 100 of the intelligent dispatching system. For example, the processing device 110 obtains, via the network 140, from the terminal device 120 the dispatching mode input by the user. For example, the processing device 110 obtains, via the network 140 and from the storage device 130, the mapping relationship between construction tasks and construction skills, or the like. In some embodiments, the network 140 includes any one or a plurality of wired networks or wireless networks. In some embodiments, the network 140 includes a cable network, an optical fiber network, a telecommunication network, the Internet, a Local Area Network (LAN), a Wide Area Network (WAN), a Wireless Local Area Network (WLAN), a Metropolitan Area Network (MAN), a Public Switched Telephone Network (PSTN), a Bluetooth network, a ZigBee network, Near Field Communication (NFC), an in-device bus, an in-device line, a cable connection, or any combination thereof. In some embodiments, a network connection between the components of the application scenario 100 of the intelligent dispatching system can adopt one of the aforementioned manners, or can adopt a plurality of manners. In some embodiments, the network may be various topological structures such as point-to-point, shared, centralized, or a combination of a plurality of topological structures.

FIG. 1B is an exemplary schematic diagram illustrating interaction among a construction management server, an administrator terminal, and a worker terminal according to some embodiments of the present disclosure. As shown in FIG. 1B, the processing device 110 is the construction management server, and the intelligent dispatching system 112 is deployed on the construction management server 110. The terminal device 120 includes a worker terminal 122 and an administrator terminal 124.

The worker terminal 122 is capable of realizing interaction between a worker and the intelligent dispatching system 112. For example, the worker terminal 122 is capable of receiving construction skills input by the worker. For example, the worker terminal 122 is capable of receiving the construction tasks dispatched by the processing device 110. For example, the worker terminal 122 is configured to generate a task schedule based on the construction tasks in progress of the workers and the currently received construction tasks. The worker terminal 122 is further configured to update the task schedule based on a completion status of the construction tasks in progress and the currently received construction tasks submitted by the workers and periodically send the task schedule of the workers to the processing device 110. In some embodiments, the worker terminal 122 may include a mobile device 122-1, a tablet computer 122-2, a laptop computer 122-3, a desktop computer 122-4, other devices with input and/or output functions, or any combination thereof.

The administrator terminal 124 is capable of realizing interaction between an administrator and the intelligent dispatching system 112. For example, the administrator terminal 124 is configured to receive dispatching purposes, dispatching modes, and standard skill factors of construction skills input by the administrator. For example, the administrator terminal 124 is configured to display a construction project plan to the administrator and receive construction tasks to be assigned input by a user based on the construction project plan. In some embodiments, the administrator terminal 124 may include a mobile device 124-1, a tablet computer 124-2, a laptop computer 124-3, a desktop computer 124-4, other devices with input and/or output functions, or any combination thereof.

It should be noted that the above description is provided for illustrative purposes only and is not intended to limit the scope of the present disclosure. For those skilled in the art, with the guidance of the content of the present disclosure, a plurality of variations and modifications may be made. Features, structures, manners, and other features of exemplary embodiments described in the present disclosure may be combined in various manners to obtain additional and/or alternative exemplary embodiments. However, the variations and modifications do not depart from the scope of the present disclosure.

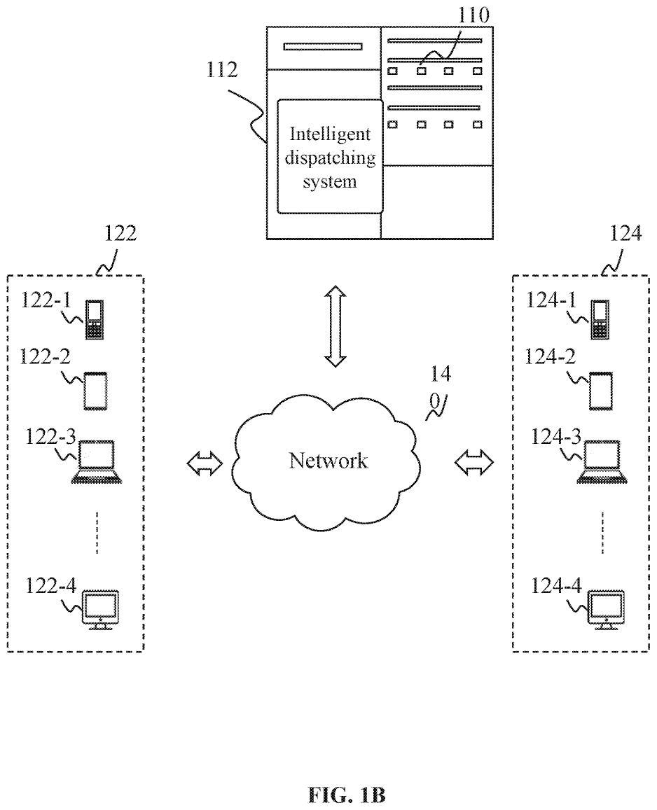

FIG. 2 is a block diagram illustrating an exemplary intelligent dispatching system according to some embodiments of the present disclosure. The intelligent dispatching system 200 may be deployed on the construction management server. As shown in FIG. 2, the intelligent dispatching system 200 may include a relationship establishing module 210, a skill quantification module 220, a task obtaining module 230, and a task assignment module 240.

The relationship establishing module 210 may be used for establishing a mapping relationship between construction tasks and construction skills. In some embodiments, the relationship establishing module 210 may be used for obtaining the mapping relationship between construction tasks and construction skills from the construction management server. In some embodiments, the mapping relationship between construction tasks and construction skills is established by the administrator terminal and uploaded to the construction management server. More descriptions of the relationship establishing module 210 may be found in operation 310.

The skill quantification module 220 may be used for obtaining construction skills and historical construction task information of the workers in a construction organization, and determining quantitative parameters of the corresponding construction skills based on the historical construction task information. In some embodiments, the quantitative parameters of the construction skills may at least include a cost parameter, a quality parameter, and a capacity parameter. In some embodiments, the skill quantification module 220 may perform one or more of following operations: obtaining a standard skill factor of the construction skills; determining a personal skill factor of each of the one or more workers according to the historical construction task information of the one or more workers; and determining quantitative parameters of the construction skills of the one or more workers based on the standard skill factor and the personal skill factor of each of the one or more workers. In some embodiments, the standard skill factor is configured to quantify an industry benchmark of the construction skill. In some embodiments, the skill quantification module 220 may perform one or more of following operations: obtaining evaluation parameters of the construction skills of the one or more workers according to the historical construction task information of the one or more workers; and correcting the quantitative parameters of the construction skills of the one or more workers based on the evaluation parameters of the construction skills of the one or more workers. In some embodiments, the evaluation parameters may at least include a cooperation intention parameter and a customer satisfaction parameter. In some embodiments, the skill quantification module 220 may perform one or more of following operations: obtaining at least one quantitative parameter of at least one construction skill corresponding to at least one time period; determining at least one time weight corresponding to the at least one time period; and determining the quantitative parameters of construction skills based on the at least one quantitative parameter of the at least one construction skill corresponding to the at least one time period and the at least one time weight corresponding to the at least one time period. In some embodiments, the skill quantification module 220 may perform one or more of following operations: adjusting a target construction period a plurality of times to obtain a plurality of second sets corresponding to a plurality of target construction periods; determining a cost-duration coefficient corresponding to each second set based on a combination cost parameter and the target construction period corresponding to each second set; and sorting the plurality of second sets according to the cost-duration coefficient, determining a fifth set based on a sorting result, and dispatching construction tasks to the workers in the fifth set. In some embodiments, the skill quantification module 220 may be used for performing one or more of following operations: obtaining historical construction task information of the one or more workers in the construction organization from the construction management server, and obtaining the construction skills of the one or more workers from one or more worker terminals of the one or more workers; and determining quantitative parameters of corresponding construction skills based on the historical construction task information. In some embodiments, the quantitative parameters of the construction skills at least include a cost parameter, a quality parameter, and a capacity parameter. More descriptions of the skill quantification module 220 may be found in operation 320.

The task obtaining module 230 may be used for obtaining the construction tasks to be assigned in the construction project. In some embodiments, the task obtaining module 230 may be used for obtaining the construction tasks to be assigned in the construction project from the construction management server. More descriptions of the task obtaining module 230 may be found in operation 330.

The task assignment module 240 may be used for dispatching construction tasks to the workers in the construction organization based on the mapping relationship, according to the construction tasks to be assigned and the quantitative parameters of construction skills. In some embodiments, the task assignment module 240 may perform one or more of following operations: screening initial workers from the construction organization according to a preset qualification condition; determining a target construction period corresponding to the construction task to be assigned; and determining selected workers from the initial workers based on the target construction period. In some embodiments, the task assignment module 240 may perform one or more of the following operations: determining a target construction skill corresponding to the construction task to be assigned based on the mapping relationship; and sorting the selected workers according to quality parameters of the target construction skill of each of the selected workers to obtain a worker sequence. In some embodiments, the task assignment module 240 may perform one or more of following operations: determining at least one initial worker combination from the worker sequence; determining at least one combination capacity factor corresponding to the at least one initial worker combination based on a personal capacity skill factor of each worker in each of the at least one initial worker combination; determining a target capacity corresponding to the target construction period and a target workload of the construction task to be assigned; and determining at least one first set from the at least one initial worker combination based on the target capacity and the at least one combination capacity factor, wherein the combination capacity factor corresponding to the first set satisfies the target capacity. In some embodiments, the task assignment module 240 may perform one or more of following operations: obtaining a dispatching mode; and dispatching construction tasks to the workers in the construction organization based on the dispatching mode and the at least one first set. In some embodiments, the dispatching mode may include a first dispatching mode. In some embodiments, the task assignment module 240 may perform one or more of following operations: determining at least one combination cost parameter corresponding to the at least one first set based on cost parameters of each of the one or more workers in each of the initial worker combinations; and determining a minimum combination cost parameter among the at least one combination cost parameter corresponding to the at least one first set, designating the first set corresponding to the minimum combination cost parameter as a second set, and dispatching construction tasks to the workers in the second set. In some embodiments, the dispatching mode may include a second dispatching mode. In some embodiments, the task assignment module 240 may perform one or more of following operations: adjusting the target construction period a plurality of times to obtain a plurality of second sets corresponding to a plurality of target construction periods; determining a cost standard value based on the plurality of second sets, and determining at least one third set from the plurality of second sets based on the cost standard value; and determining a shortest target construction period among the at least one target construction period corresponding to the at least one third set, designating the third set corresponding to the shortest target construction period as a fourth set, and dispatching construction tasks to the workers in the fourth set. In some embodiments, the dispatching mode may include a third dispatching mode. In some embodiments, the task assignment module 240 may perform one or more of following operations: adjusting the target construction period a plurality of times to obtain a plurality of second sets corresponding to a plurality of target construction periods; determining a cost-duration coefficient corresponding to each second set based on the combination cost parameter and the target construction period corresponding to each second set; and sorting the plurality of second sets according to the cost-duration coefficient, determining the fifth set based on a sorting result, and dispatching construction tasks to the workers in the fifth set. In some embodiments, the task assignment module 240 may perform one or more of following operations: determining at least one target worker from the one or more workers based on the mapping relationship, according to the construction task to be assigned and the quantitative parameters of construction skills; and dispatching the construction task to be assigned to at least one target worker terminal of the at least one target worker. More descriptions of the task assignment module 240 may be found in operation 340.

In some embodiments, the intelligent dispatching system 200 may further include an update module 250. The update module 250 may be used for updating the quantitative parameters of the construction skills. In some embodiments, the update module 250 may perform one or more of following operations: periodically receiving a target task schedule sent by a target terminal; determining a construction task status of a target worker based on the target task schedule; updating the historical construction task information when a change in the construction task status of any worker is detected; and updating the quantitative parameters of construction skills based on the updated historical construction task information. In some embodiments, the target task schedule is generated by a target worker terminal based on the construction tasks in progress of the target worker and the currently received construction tasks and is updated by the target worker terminal based on the completion status of the construction tasks in progress and the currently received construction tasks submitted by the target worker.

In some embodiments, the relationship establishing module 210, the skill quantification module 220, the task obtaining module 230, the task assignment module 240, and the update module 250 may be implemented on the same or different processing devices.

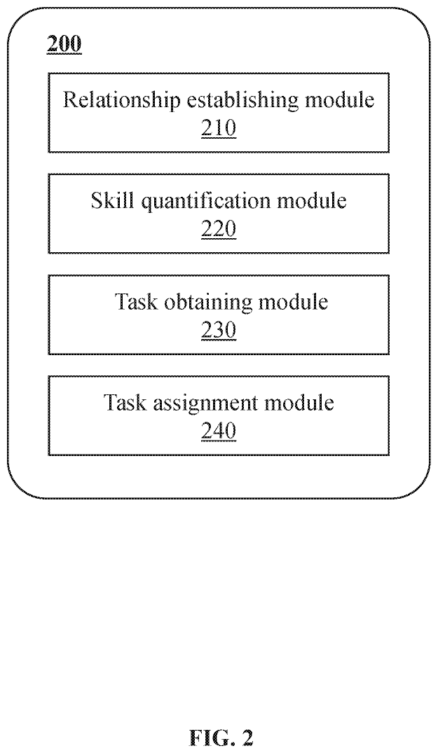

FIG. 3 is a flowchart illustrating an exemplary intelligent dispatching process according to some embodiments of the present disclosure. In some embodiments, the process 300 may be performed by the processing device 110 or the intelligent dispatching system 200. For example, the process 300 may be stored in a storage device in the form of programs or instructions, and the process 300 may be implemented when the processing device 110 or the intelligent dispatching system 200 executes the instructions. The schematic diagram of operations of the process 300 presented below is illustrative. In some embodiments, the process may be completed by one or more undescribed additional operations and/or one or more undiscussed operations. In addition, the order of operations of process 300 shown in FIG. 3 and described below is not restrictive.

In 310, obtaining a mapping relationship between construction tasks and construction skills from the construction management server. The mapping relationship between the construction tasks and the construction skills is established. Specifically, the operation 310 may be performed by the relationship establishing module 210.

The construction task may be specific work content for completing a construction project. For example, where the construction project is foundation engineering, the corresponding construction tasks may include earth excavation, foundation pit support, concrete cushion, foundation sidewall formwork, chalk line drawing, mat foundation, rebar reinforcement, mat masonry, and earth backfill.

The construction skill may be related technologies and abilities required to complete a construction project. Continuing the above example, the construction skills corresponding to ‘foundation engineering’ may include the excavator operation, the compactor operation, the concrete pouring, the rebar fabrication, and the rebar framework installation. In some embodiments, the relationship establishing module 210 represents a construction skill using a worker type label corresponding to the construction skill. Continuing the above example, the excavator operation, the compactor operation, the concrete pouring, the rebar fabrication, and the rebar framework installation may be respectively represented by labels such as ‘excavator operator’, ‘compactor operator’, ‘concrete worker’, and ‘rebar worker’.

The mapping relationship between construction tasks and construction skills may be a correspondence relationship between a construction task and the construction skills required to complete the construction task. For example, the mapping relationship may include a correspondence relationship between a construction task ‘earth excavation’ and a construction skill ‘excavator operator’. As another example, the mapping relationship may include a correspondence relationship between a construction task ‘rebar reinforcement’ and a construction skill ‘rebar worker’.

In some embodiments, the relationship establishing module 210 may determine construction tasks and construction skills included in the construction projects of the entire industry based on historical construction project data of the construction industry (e.g., planning documents, acceptance reports, engineering cost tables, project schedule tables, and construction cost settlement forms of historical construction projects), and then establish a mapping relationship between construction tasks and construction skills. For example, the relationship establishing module 210 may determine that a historical construction task ‘earth excavation’ requires an excavator operator based on the historical construction project data, thereby establishing a mapping relationship between the construction task ‘earth excavation’ and the construction skill ‘excavator operator’.

In some embodiments, the relationship establishing module 210 may obtain the mapping relationship between construction tasks and construction skills from the construction management server (e.g., other systems of the construction management server or storage devices of the construction management server). The mapping relationship between the construction tasks and the construction skills is established by an administrator terminal 124 and then uploaded to the construction management server. A process in which the administrator terminal 124 establishes the mapping relationship between construction tasks and construction skills is similar to a process in which the relationship establishing module 210 establishes the mapping relationship between construction tasks and construction skills, which may not be repeated herein. Further, the relationship establishing module 210 may obtain the mapping relationship between construction tasks and construction skills from the administrator terminal 124 through the network 140.

In 320, obtaining construction skills and historical construction task information of the workers in the construction organization, and determining quantitative parameters of the corresponding construction skills based on the historical construction task information. Specifically, the operation 320 may be performed by the skill quantification module 220.

The construction organization may be a collection of workers that complete various construction tasks. For example, the construction organization may be an engineering company, an engineering project team, or an engineering contractor.

The construction skills of workers in the construction organization may be related technologies and abilities possessed by the workers to complete construction tasks. Each worker in the construction organization may possess one or more construction skills, that is, each worker in the construction organization may be capable of completing one or more construction tasks. For example, an engineering project team includes 100 workers, wherein a worker A possesses the construction skills ‘excavator operator’ and ‘compactor operator’, a worker B possesses the construction skill ‘rebar worker’, and a worker C possesses both the construction skills ‘excavator operator’ and ‘rebar worker’.

In some embodiments, the skill quantification module 220 may determine the construction skills of workers based on basic information of the workers in the construction organization. For example, basic information of the workers may be information such as worker names, ID card numbers, health examination reports, and skill certificates input by the user.

In some embodiments, the skill quantification module 220 obtains the construction skills of one or more workers from one or more worker terminals 122 of the one or more workers. Each worker in the construction organization may input his or her basic information and construction skills through the worker terminal 122. The skill quantification module 220 may obtain the construction skills of the workers from one or more worker terminals 122 through the network 140 based on basic information of the workers in the construction organization.

The historical construction task information of the workers in the construction organization may be related to historical construction tasks completed by the workers. For example, historical construction task information of worker C may include related information of the historical construction task ‘Earth Excavation for Project A’, ‘Rebar Reinforcement for Project A’, ‘Earth Excavation for Project B’, and ‘Rebar Reinforcement for Project C’ completed by worker C. In some embodiments, historical construction task information may include the workload, the construction time, the labor costs, and the acceptance reports of historical construction tasks completed by the workers.

In some embodiments, the skill quantification module 220 may determine historical construction task information of the workers based on historical construction project data of the construction organization. For example, historical construction task information of the worker C may be determined based on the project data of ‘Project A’, ‘Project B’, and ‘Project C’ of the construction organization.

In some embodiments, the skill quantification module 220 obtains historical construction task information of the one or more workers in the construction organization from the construction management server (e.g., other systems of the construction management server or storage devices of the construction management server). Specifically, the construction management server may determine historical construction task information of the workers based on the historical construction project data of the construction organization. A process in which the construction management server determines historical construction task information of the workers based on the historical construction project data of the construction organization is similar to a process in which the skill quantification module 220 determines historical construction task information of the workers based on the historical construction project data of the construction organization, which may not be repeated herein. Further, the skill quantification module 220 may obtain historical construction task information of the workers in the construction organization from the construction management server (e.g., other systems of the construction management server or storage devices of the construction management server) through the network 140.

The quantitative parameters of the construction skills are relative indexes used to evaluate the construction skills of the workers. In some embodiments, the quantitative parameters of the construction skills may at least include a cost parameter, a quality parameter, and a capacity parameter. The cost parameter, the quality parameter, and the capacity parameter may respectively quantify the relative level of the construction skills of the workers in the industry from three dimensions: cost, quality, and capacity.

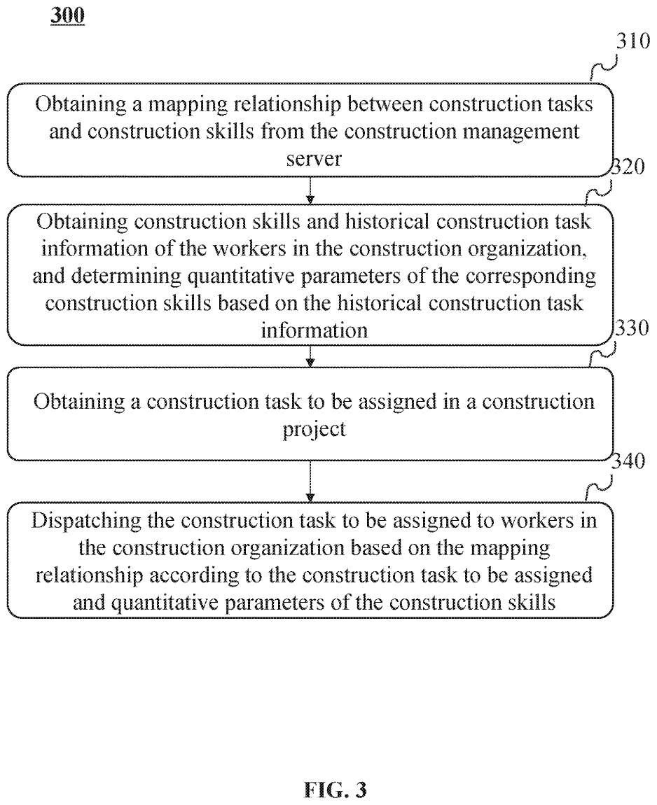

More descriptions of determining the quantitative parameters of the corresponding construction skills based on historical construction task information may be found in FIG. 4 and its descriptions.

In 330, obtaining a construction task to be assigned in a construction project. Specifically, the operation 330 may be performed by the task obtaining module 230.

The construction task to be assigned may be a construction task that requires construction workers to be arranged. In some embodiments, the task obtaining module 230 may obtain the construction task to be assigned based on a construction project planning document. For example, the task obtaining module 230 may extract the construction task to be assigned from the construction project planning document through a text extraction model (e.g., a Bidirectional Encoder Representations from Transformers (BERT) model). As another example, the task obtaining module 230 may display the construction project planning document to the user through the terminal device 120, and receive the construction task to be assigned input by the user based on the construction project planning document.

For example, the task obtaining module 230 may obtain construction tasks to be assigned ‘earth excavation’ and ‘rebar reinforcement’ based on planning document of a construction project C.

In some embodiments, the task obtaining module 230 obtains the construction task to be assigned in the construction project from the construction management server (e.g., other systems of the construction management server or storage devices of the construction management server). Specifically, the construction management server may obtain the construction task to be assigned based on the construction project planning document. The manner in which the construction management server obtains the construction task to be assigned based on the construction project planning document is similar to the manner in which the task obtaining module 230 obtains the construction task to be assigned based on the construction project planning document, details of which will not be repeated herein. Further, the task obtaining module 230 may obtain the construction task to be assigned from the construction management server through the network 140.

In 340, dispatching the construction task to be assigned to workers in the construction organization based on the mapping relationship according to the construction task to be assigned and quantitative parameters of the construction skills. Specifically, the operation 340 may be performed by the task assignment module 240.

To prevent dispatching construction tasks to workers without a construction schedule or workers not meeting qualification requirements, the task assignment module 240 may first determine the workers in the construction organization who have a construction schedule and meet the qualification requirements.

Specifically, in some embodiments, the task assignment module 240 may screen initial workers from the construction organization according to a preset qualification condition. The preset qualification conditions may be basic conditions preset for screening the workers. For example, the preset qualification condition may include: completing safety education, not being blacklisted, passing physical examinations, and meeting age requirements. The initial workers may be the workers in the construction organization who meet preset qualification conditions. For example, according to preset qualification conditions, the task assignment module 240 may screen out 50 initial workers from 100 workers of a certain engineering project team.

Furthermore, in some embodiments, the task assignment module 240 may determine a target construction period corresponding to the construction task to be assigned. For example, the task assignment module 240 may further obtain the target construction period and a target workload corresponding to the construction task to be assigned based on a construction project plan. For example, for the construction task to be assigned ‘earth excavation’, the target construction period is 1 month and the target workload is 106 m³; for ‘reinforcement strengthening’, the target construction period is 3 months from the current time and the target workload is 10 t.

Furthermore, in some embodiments, the task assignment module 240 may determine selected workers from the initial workers based on the target construction period. For example, the task assignment module 240 may determine the workers among the initial workers whose idle schedule and the target construction period have an overlap greater than a preset value (e.g., 90%) as the selected workers. Wherein the preset value may be adjusted based on the ideal number of the selected workers. For example, based on the target construction period of ‘1 month’ for ‘earth excavation’, the task assignment module 240 may determine 30 selected workers from the 50 initial workers.

In some embodiments of the present disclosure, determining the selected workers from the initial workers based on preset qualification conditions and the target construction period corresponding to the construction task to be assigned may eliminate workers who do not meet the qualification requirements and do not have appropriate schedules in advance, thereby improving the efficiency of subsequent dispatching.

To improve dispatching efficiency, the task assignment module 240 may determine the workers in the construction organization who possess construction skills corresponding to the construction task to be assigned.

Specifically, in some embodiments, the task assignment module 240 may determine a target construction skill corresponding to the construction task to be assigned based on the mapping relationship. For example, based on the correspondence between the construction task ‘earth excavation’ and the construction skill ‘excavator operator’ in the mapping relationship, the target construction skill corresponding to the construction task to be assigned ‘earth excavation’ is determined as ‘excavator operator’; based on the correspondence between the construction task ‘reinforcement strengthening’ and the construction skill ‘rebar worker’ in the mapping relationship, the target construction skill corresponding to the construction task to be assigned ‘reinforcement strengthening’ is determined as ‘rebar worker’.

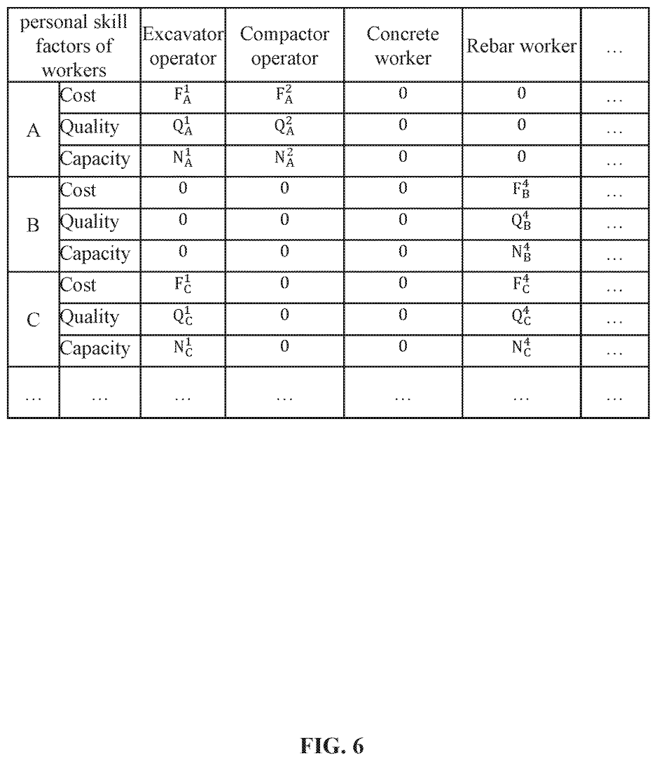

Furthermore, in some embodiments, the task assignment module 240 may sort the selected workers according to quality parameters of the target construction skill of each of the selected workers to obtain a worker sequence. FIG. 7 is a schematic diagram illustrating an exemplary worker sequence according to some embodiments of the present disclosure. For example, as shown in FIG. 7, taking the target construction skill ‘excavator operator’ as an example, the task assignment module 240 may sort the 30 selected workers in a descending order according to quality parameters of the ‘excavator operator’ for each of the 30 selected workers, to obtain the worker sequence [A, C, . . . . B]. For example, if quality parameter 0.8 of A is higher than 0.7 of C, then a position of A is before a position of B in the worker sequence.

In some embodiments of the present disclosure, obtaining the worker sequence according to quality parameters of the target construction skill of the selected workers may ensure that the selected workers are more in line with construction task requirements, and at the same time guarantee construction quality of the construction task, avoiding dispatching workers who are not proficient in corresponding construction skills to unsuitable construction tasks.

To ensure that the dispatching satisfies the construction period and quality requirements, the task assignment module 240 may screen a worker set that meets the requirements based on the worker sequence.

Specifically, in some embodiments, the task assignment module 240 may determine at least one initial worker combination from the worker sequence. In some embodiments, the task assignment module 240 may pre-process the worker sequence before determining the at least one initial worker combination. The pre-processing may further improve overall quality parameters of the worker sequence. In some embodiments, the pre-processing may obtain an average quality parameter of the worker sequence based on the quality parameters of a plurality of workers in the worker sequence, and then exclude the workers in the worker sequence whose quality parameters are lower than the average quality parameter. For example, the pre-processing may exclude 20 workers whose quality parameters are lower than the average quality parameter from the 30-person worker sequence, thereby obtaining the 10-person worker sequence.

The initial worker combination may be a sub-set of the worker sequence. For example, the 10-person worker sequence may include 1022 sub-sets, that is, 1022 initial worker combinations

$${C}_{10}^{1} {C}_{10}^{2} {C}_{10}^{3} {C}_{10}^{4} {C}_{10}^{5} {C}_{10}^{6} {C}_{10}^{7} {C}_{10}^{8} {C}_{10}^{9} {C}_{10}^{10} .$$

Furthermore, in some embodiments, the task assignment module 240 may determine at least one combination capacity factor corresponding to the at least one initial worker combination based on a personal capacity skill factor of each worker in each initial worker combination. More descriptions of the personal capacity skill factor of the workers may be found in the related descriptions of the operation 410. The combination capacity factor may be a sum of personal capacity skill factors of construction skills of all the workers in the corresponding initial worker combination. For example, if an initial worker combination K1 corresponding to ‘excavator operator’ includes 5 workers in the worker sequence, then the corresponding combination capacity factor is the sum of personal capacity skill factors of the 5 workers

$${N}_{K 1}^{1} .$$

Furthermore, in some embodiments, the task assignment module 240 may determine a target capacity corresponding to the construction task to be assigned according to the target construction period and the target workload. For example, the task assignment module 240 may determine the corresponding target capacity as 106/30=33400 m³/d based on the target construction period of 1 month and the target workload of 106 m³ for the construction task to be assigned ‘earth excavation’.

In some embodiments, the task assignment module 240 may determine the at least one first set from the at least one initial worker combination based on the target capacity and the at least one combination capacity factor. The combination capacity factor corresponding to the first set satisfies the target capacity. For example, the combination capacity factor corresponding to the initial worker combination K1 is 2000 m³/h=16000 m³/d, which does not satisfy the target capacity; a combination capacity factor corresponding to an initial worker combination K2 is 5000 m³/h=40000 m³/d, which satisfies the target capacity; then the initial worker combination K2 may be determined as the first set

$${N}_{K 1}^{1} {N}_{K 2}^{1} .$$

Illustratively, the task assignment module 240 may determine 200 first sets from 1022 initial worker combinations.

In some embodiments of the present disclosure, determining the at least one first set from the at least one initial worker combination based on the target capacity may ensure that the construction task is completed according to the target construction period.

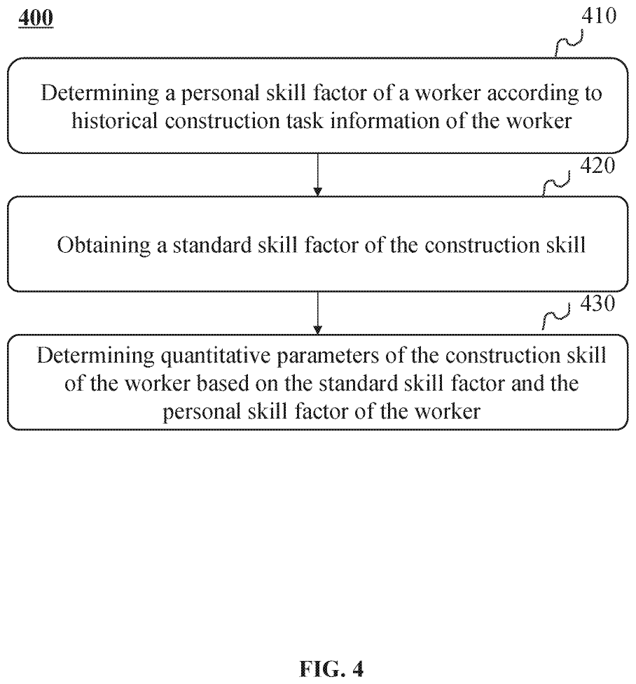

In some embodiments, the task assignment module 240 may dispatch the construction task to the workers in the construction organization based on the at least one first set. More descriptions of dispatching the construction task to the workers in the construction organization based on the first set may be found in FIG. 5 and its descriptions.

In some embodiments, the task assignment module 240 may determine at least one target worker from the selected workers. The target worker refers to a worker who accepts the construction task. Specifically, the task assignment module 240 may determine the target construction skill corresponding to the construction task to be assigned based on the mapping relationship; sort the selected workers according to quality parameters of the target construction skill of the selected workers to obtain the worker sequence; and determine the at least one target worker based on the worker sequence.

In some embodiments, the task assignment module 240 may determine at least one initial worker combination from the worker sequence; determine at least one combination capacity factor corresponding to the at least one initial worker combination based on a personal capacity skill factor of each worker in each initial worker combination; and determine the target capacity corresponding to the construction task to be assigned according to the target construction period and the target workload.

In some embodiments, the task assignment module 240 may further determine at least one first set from the at least one initial worker combination based on the target capacity and the at least one combination capacity factor, wherein the combination capacity factor corresponding to the first set satisfies the target capacity; and determine the at least one target worker based on the at least one first set. More descriptions of determining the at least one target worker based on the at least one first set may be found in FIG. 5 and its descriptions.

In some embodiments, the task assignment module 240 may dispatch the construction task to at least one target worker terminal of at least one target worker. For example, the task assignment module 240 may dispatch the construction task to at least one target worker terminal 122 of at least one target worker through the network 140.

In some embodiments of the present disclosure, by establishing the mapping relationship between construction skills and construction tasks, quantifying construction skills of the workers from a plurality of dimensions such as capacity, cost, and quality, and dispatching construction tasks to the workers in the construction organization based on the mapping relationship and according to the construction task to be assigned and quantified construction skills (i.e., the quantitative parameters) may improve dispatching efficiency while taking into account the construction period, cost, and quality requirements of the construction task.

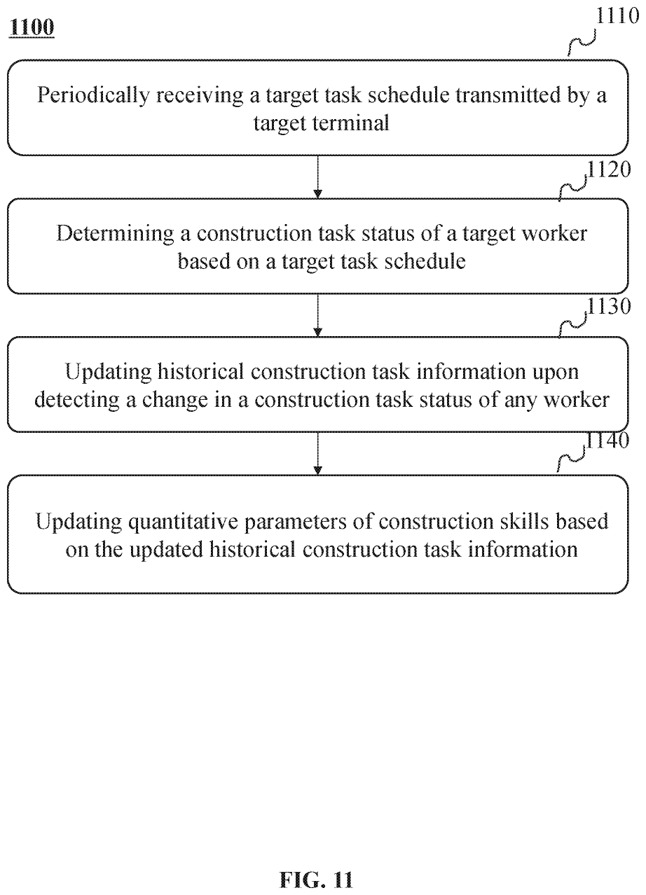

In some embodiments, the processing device 110 or the intelligent dispatching system 200 may update the quantitative parameters of construction skills. More descriptions of updating the quantitative parameters of construction skills may be found in FIG. 11 and its related descriptions.

FIG. 4 is a flowchart illustrating an exemplary process of determining quantitative parameters of construction skills of one or more workers according to some embodiments of the present disclosure. In some embodiments, the process 400 may be performed by the processing device 110 or the intelligent dispatching system 200 (e.g., the skill quantification module 220). For example, the process 400 may be stored in a storage device in the form of programs or instructions. The process 400 may be implemented when the processing device 110 or the intelligent dispatching system 200 (e.g., the skill quantification module 220) executes the instructions. The schematic diagram of the operations of the process 400 presented below is illustrative. In some embodiments, the process may be accomplished with one or more additional operations not described and/or one or more operations not discussed. Additionally, the order of the operations of process 400 shown in FIG. 4 and described below is not limited.

In 410, determining the personal skill factor of the worker according to the historical construction task information of the worker.

The personal skill factor of the worker refers to an absolute indicator used for evaluating the construction skills of the worker. Corresponding to the quantitative parameters, in some embodiments, the personal skill factor of the worker may include a cost personal skill factor, a quality personal skill factor, and a capacity personal skill factor. The cost personal skill factor, the quality personal skill factor, and the capacity personal skill factor may respectively quantify the absolute level of the construction skills of the worker from three dimensions of cost, quality, and capacity.

The cost personal skill factor may be represented by the average remuneration obtained by the worker for completing a unit construction task workload. For example, the skill quantification module 220 may obtain a total construction task workload corresponding to a certain construction skill of the worker and a total remuneration obtained for completing the total construction task workload from the historical construction task information of the worker, and then obtain a cost personal skill factor corresponding to the construction skill of the worker based on the ratio of the total remuneration to the total construction task workload. For example, continuing the above example, the skill quantification module 220 may obtain, from the historical construction task information of the worker C (including: a construction task workload of ‘Earthwork Excavation for Project A’ being ‘800 m³’, construction time ‘1 h’, construction remuneration ‘300 Yuan’, acceptance ‘qualified’; a construction task workload of ‘Earthwork Excavation for Project B’ being ‘1600 m³’, construction time ‘3 h’, construction remuneration ‘500 Yuan’, acceptance ‘qualified’; a construction task workload of ‘Rebar Reinforcement for Project A’ being ‘1 t’, construction time ‘4 h’, construction remuneration ‘900 Yuan’, acceptance ‘unqualified’; and a construction task workload of ‘Rebar Reinforcement for Project C’ being ‘2 t’, construction time ‘8 h’, construction remuneration ‘2000 Yuan’, acceptance ‘qualified’), that the total construction task workload corresponding to the construction skill ‘excavator operator’ of the worker C is 800+1600-2400 m³ and the total remuneration is 800 Yuan. Then, based on the ratio of the total remuneration of 800 Yuan to the total construction task workload of 2400 m³, the skill quantification module 220 determines the cost personal skill factor

$${F}_{C}^{1}$$

corresponding to the construction skill ‘excavator operator’ of the worker C as 0.33 Yuan/m³. The skill quantification module 220 may also obtain that the total construction task workload corresponding to the construction skill ‘rebar worker’ of the worker C is 1+2=3 t and the total remuneration is 2900 Yuan. Then, based on the ratio of the total remuneration of 2900 Yuan to the total construction task workload of 3 t, the skill quantification module 220 determines the cost personal skill factor

$${F}_{C}^{4}$$

corresponding to the construction skill ‘rebar worker’ of the worker C as 966.7 Yuan/t.

The quality personal skill factor may be represented by a quality pass rate of the construction tasks of the worker. For example, the skill quantification module 220 may obtain a total construction task workload corresponding to a certain construction skill of the worker and a qualified construction task workload by acceptance from the historical construction task information of the worker, and then obtain a quality personal skill factor corresponding to the construction skill of the worker based on the ratio of the qualified construction task workload by acceptance to the total construction task workload. For example, continuing the above example, the skill quantification module 220 may obtain, from the historical construction task information of the worker C, that the total construction task workload corresponding to the construction skill ‘excavator operator’ of the worker C is 800+1600=2400 m³ and the qualified construction task workload by acceptance is 800+1600=2400 m³. Then, based on the ratio of the qualified construction task workload of 2400 m³ by acceptance to the total construction task workload of 2400 m³, the skill quantification module 220 determines the quality personal skill factor

$${Q}_{C}^{1}$$

corresponding to the construction skill ‘excavator operator’ of the worker C as 100%. The skill quantification module 220 may also obtain that the total construction task workload corresponding to the construction skill ‘rebar worker’ of the worker C is 1+2=3 t and the qualified construction task workload by acceptance is 2 t. Then, based on the ratio of the qualified construction task workload of 2 t by acceptance to the total construction task workload of 3 t, the skill quantification module 220 determines the quality personal skill factor

$${Q}_{C}^{4}$$

corresponding to the construction skill ‘rebar worker’ of the worker C as 66.7%.

The capacity personal skill factor may be represented by the average construction task workload completed by the worker per unit time. For example, the skill quantification module 220 may obtain the total construction task workload corresponding to a certain construction skill of the worker and the total time required to complete the total construction task workload from the historical construction task information of the worker, and then obtain the capacity personal skill factor corresponding to the construction skill of the worker based on the ratio of the total construction task workload to the total time. For example, continuing the above example, the skill quantification module 220 may obtain, from the historical construction task information of the worker C, that the total construction task workload corresponding to the construction skill ‘excavator operator’ of the worker C is 800+1600=2400 m³ and the total time is 1+3=4 h. Then, based on the ratio of the total construction task workload of 2400 m³ to the total time of 4 h, the skill quantification module 220 determines the capacity personal skill factor

$${N}_{C}^{1}$$

corresponding to the construction skill ‘excavator operator’ of the worker C as 600 m³/h. The skill quantification module 220 may also obtain that the total construction task workload corresponding to the construction skill ‘rebar worker’ of the worker C is 1+2=3 t and the total time is 4+8=12 h. Then, based on the ratio of the total construction task workload of 3 t to the total time of 12 h, the skill quantification module 220 determines the capacity personal skill factor

$${N}_{C}^{4}$$

corresponding to the construction skill ‘rebar worker’ of the worker C as 0.25 t/h.

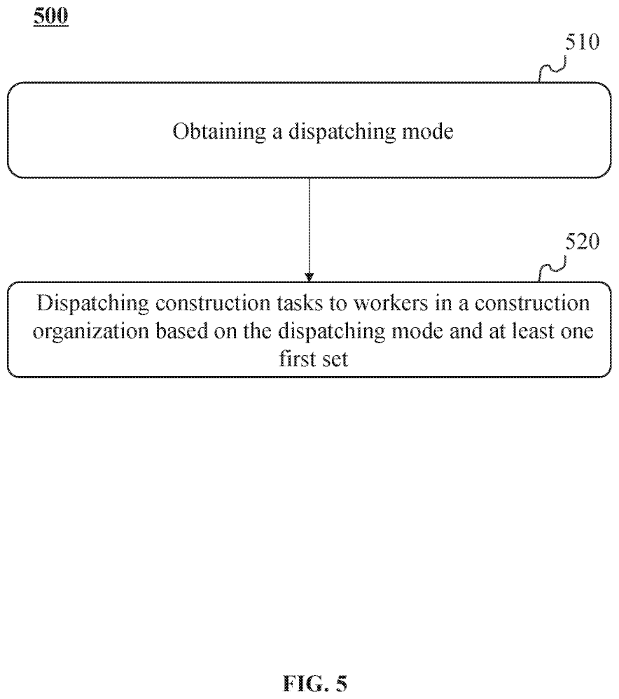

FIG. 6 is a schematic diagram illustrating exemplary personal skill factors of construction skills of workers according to some embodiments of the present disclosure. As shown in FIG. 6, the personal skill factor of construction skills not possessed by a worker C may be represented by ‘0’. Similarly, the skill quantification module 220 may obtain, based on the historical construction task information of worker A, the personal skill factors

$${F}_{A}^{1} , {Q}_{A}^{1} , {N}_{A}^{1}$$

for the construction skill ‘excavator operator’ of worker A and the personal skill factors

$${F}_{A}^{2} , {Q}_{A}^{2} , {N}_{A}^{2}$$

for the construction skill ‘compactor operator’. The skill quantification module 220 may also obtain, based on the construction task information of worker B, the personal skill factors

$${F}_{B}^{4} , {Q}_{B}^{4} , {N}_{B}^{4}$$

for the construction skill ‘rebar worker’ of worker B.

In 420, obtaining a standard skill factor of the construction skill.

The standard skill factor of a construction skill may be a benchmark parameter representing the industry level of the construction skill. Corresponding to the quantitative parameters, in some embodiments, the standard skill factor may include cost standard skill factor, quality standard skill factor, and capacity standard skill factor. The cost standard skill factor, the quality standard skill factor, and the capacity standard skill factor may respectively represent the industry level from three dimensions of cost, quality, and capacity.

In some embodiments, the standard skill factor of the construction skill may include, but is not limited to, the highest value, the lowest value, the average value, and the standard deviation of the personal skill factor of construction skills of the worker in the industry, or the like.

In some embodiments, the skill quantification module 220 may obtain the standard skill factor of a construction skill based on historical construction project data of the construction industry. For example, taking the cost standard skill factor of the construction skill ‘excavator operator’ as an example, the cost standard skill factor of the construction skill ‘excavator operator’ includes a first cost standard skill factor and a second cost standard skill factor. The skill quantification module 220 may obtain, based on historical construction project data of the construction industry, the highest value of the cost personal skill factor of construction skills of the worker in the industry as the first cost standard skill factor

$${F}_{max}^{1} = 0.43 Yuan / {m}^{3} ,$$

and the lowest value of the cost personal skill factor of construction skills of the worker in the industry as the second cost standard skill factor

$${F}_{min}^{1} = 0.23 Yuan / {m}^{3} .$$

As another example, taking the quality standard skill factor of the construction skill ‘rebar worker’ as an example, the skill quantification module 220 may obtain, based on historical construction project data of the construction industry, the average value of the quality personal skill factor of construction skills of a worker in the industry as the quality standard skill factor

$${Q}_{A}^{4} .$$

In some embodiments, the skill quantification module 220 may also directly obtain a user-input standard skill factor of the construction skill through the terminal device 120, which may not be limited in the embodiment

In 430, determining quantitative parameters of the construction skill of the worker based on the standard skill factor and the personal skill factor of the worker.

As can be seen from the foregoing, the quantitative parameters of construction skills are relative indicators used for evaluating the construction skills of the worker. In some embodiments, the quantitative parameters of construction skills may include a cost parameter, a quality parameter, and a capacity parameter.

Exemplarily, taking the cost parameter as an example, the cost parameter may be a value between 0 and 1. The closer the cost parameter is to 0, the more a construction skill is at a downstream level of the construction industry when evaluated from a cost dimension. Conversely, a construction skill is at an upstream level of the construction industry. The skill quantification module 220 may obtain the cost parameter of the construction skill of the worker based on the first cost standard skill factor, the second cost standard skill factor, and the cost personal skill factor of the worker. For example, the cost parameter of the construction skill of the worker may be obtained by Formula (1):

$${F}_{j}^{′ i} = {F}_{j}^{i} / ( {F}_{max}^{i} + {F}_{min}^{i} ) \qquad ( 1 )$$

wherein i represents a construction skill, j represents a worker,

$${F}_{j}^{′ i}$$

represents a cost parameter of the construction skill i of the worker j,

$${F}_{j}^{i}$$

represents a cost personal skill factor of the construction skill i of the worker j, and

$${F}_{max}^{i} and {F}_{min}^{i}$$

respectively represent a first cost standard skill factor and a second cost standard skill factor of the construction skill i.

For example, a cost parameter

$${F}_{C}^{′1} = {F}_{C}^{1} / ( {F}_{max}^{1} + {F}_{min}^{1} ) = 0.5$$

of a construction skill ‘excavator operator’ of worker C. Thus, it can be seen that the construction skill ‘excavator operator’ of worker C, when evaluated from a cost dimension, is at a middle level in the industry.

As another example, taking the quality parameter as an example, the quality parameter may be a value greater than 0. The smaller the quality parameter, the more a construction skill is at a downstream level of the construction industry when evaluated from a quality parameter dimension. Conversely, the more it is at an upstream level of the construction industry, and the closer it is to 1, the closer it is to the average level of the construction industry. The skill quantification module 220 may obtain the quality parameter of the construction skill of the worker based on the quality standard skill factor and the quality personal skill factor of the worker. For example, the quality parameter of the construction skill of the worker may be obtained by Formula (2):

$${Q}_{j}^{′ i} = {Q}_{j}^{i} / {Q}_{A}^{i} \qquad ( 2 )$$

wherein i represents a construction skill, j represents a worker,

$${Q}_{j}^{′ i}$$

represents a quality parameter of the construction skill i of the worker j,

$${Q}_{j}^{i}$$

represents a quality personal skill factor of the construction skill i of the worker j, and

$${Q}_{A}^{i}$$

represents a quality standard skill factor of construction skill i.

In some embodiments of the present disclosure, the quantitative parameters corresponding to the personal skill factor of construction skills of the worker may be determined based on different standard skill factors and different manners. This embodiment is not limited in this regard.

In some embodiments of the present disclosure, the construction skills of a worker are quantified, and the quantified absolute indicator is converted into relative indicators based on the industry level, so that the relative indicators ‘quantitative parameters’ can more intuitively reflect the relative level of the construction skills of the worker compared to the overall industry level.

As can be seen from the foregoing, the quantitative parameters of the construction skills of a worker quantify the relative level of the construction skills of the worker in the industry from three objective dimensions of cost, quality, and capacity, which is an objective evaluation of the construction skills of the worker. In order to quantify the construction skills of the worker from a subjective perspective, the skill quantification module 220 may further correct the quantitative parameters of the construction skills of the worker.

Specifically, in some embodiments, the skill quantification module 220 may obtain the evaluation parameters of the construction skill of the worker according to the historical construction task information of the worker. The evaluation parameters of the construction skills of the worker may be subjective indicators used for evaluating the construction skills of the worker. In some embodiments, the evaluation parameters may at least include a cooperation intention parameter and a customer satisfaction parameter. The cooperation intention parameter and the customer satisfaction parameter may respectively quantify the subjective feelings towards the construction skills of the worker from two perspectives of cooperation fellow workers and customers.

The cooperation intention parameter may be a parameter representing the cooperation intention of cooperation fellow workers regarding the construction skills of the worker. For example, the cooperation intention parameter may be a natural number between 0 and 10. The closer the cooperation intention parameter is to 10, the higher the cooperation intention of the fellow workers regarding the construction skills of the worker. Conversely, the lower the cooperation intention of the fellow workers regarding the construction skills of the worker.

In some embodiments, the skill quantification module 220 may obtain, according to the historical construction task information of the worker, the evaluation information regarding the construction skills of the worker from the cooperation fellow workers (e.g., a fellow worker cooperation evaluation table, fellow worker complaint information, or the like), and obtain the cooperation intention parameter of the construction skills of the worker based on the evaluation information regarding the construction skills of the worker from the cooperation fellow workers and preset cooperation intention evaluation rules. For example, the preset cooperation intention evaluation rules may include: the cooperation intention parameter of the construction skills of the worker is equal to the average evaluation score from the cooperation intention evaluation table of the worker by the cooperation fellow workers in the corresponding historical construction tasks participated by the worker. When the cooperation fellow workers in the historical construction tasks participated by the worker make a complaint each time against the worker, one point is deducted from the corresponding cooperation intention parameter of the construction skills.

For example, continuing the previous example, the skill quantification module 220 may obtain, based on the historical construction task information of worker C, the evaluation information regarding the construction skill ‘excavator operator’ of worker C from the cooperation fellow workers (including: a cooperation evaluation table from 4 fellow workers participating in ‘Earthwork Excavation for Project A’ (e.g., 8 points, 9 points, 7 points, and 8 points) and complaint information (e.g., 1 time); a cooperation evaluation table from 3 fellow workers participating in ‘Earthwork Excavation for Project B’ (e.g., 6 points, 10 points, and 9 points) and complaint information (e.g., 0 times)). The skill quantification module 220 may also obtain the evaluation information regarding the construction skill ‘rebar worker’ from the cooperation fellow workers (including: a cooperation evaluation table from 5 fellow workers participating in ‘Rebar Reinforcement for Project A’ (e.g., 7 points, 10 points, 9 points, 7 points, and 8 points) and complaint information (e.g., 2 times); and a cooperation evaluation table from 4 fellow workers participating in ‘Rebar Reinforcement for Project C’ (e.g., 8 points, 8 points, 9 points, and 6 points) and complaint information (e.g., 0 times)). Then, based on the average cooperation evaluation score (8+9+7+8+6+10+9)/7=8.14 points of the evaluation information regarding the construction skill ‘excavator operator’ of worker C from the 7 cooperation fellow workers, 1 complaint, and the preset cooperation intention evaluation rules, the skill quantification module 220 obtains the cooperation intention parameter

$${D}_{C}^{1}$$

of the construction skill ‘excavator operator’ of worker C as 8.14−1=7.14. Furthermore, based on the average cooperation evaluation score (7+10+9+7+8+8+8+9+6)/9=8 points of the evaluation information regarding the construction skill ‘rebar worker’ of worker C from the 9 cooperation fellow workers, 2 complaints, and the preset cooperation intention evaluation rules, the skill quantification module 220 obtains the cooperation intention parameter

$${D}_{C}^{4}$$

of the construction skill ‘rebar worker’ of worker C as 8−2=6.

The customer satisfaction parameter may be a parameter representing the satisfaction degree of customers regarding the construction skills of the worker. For example, the customer satisfaction parameter may be a natural number between 0 and 10. The closer the customer satisfaction parameter is to 10, the higher the satisfaction degree of the customers regarding the construction skills of the worker. Conversely, the lower the satisfaction degree of the customers regarding the construction skills of the worker.

In some embodiments, the skill quantification module 220 may obtain, according to the historical construction task information of the worker, the evaluation information regarding the construction skills of the worker from the customers (e.g., a customer satisfaction evaluation table, customer complaint information, or the like), and obtain the customer satisfaction parameter of the construction skills of the worker based on the evaluation information regarding the construction skills of the worker from the customers and preset customer satisfaction evaluation rules. Regarding obtaining the customer satisfaction parameter of the construction skills of the worker, a detailed description may refer to the relevant description of obtaining the cooperation intention parameter of the construction skills of the worker, and will not be repeated herein. For example, the customer satisfaction parameter

$${S}_{C}^{1}$$

of the construction skill ‘excavator operator’ of worker C is 8, and the customer satisfaction parameter

$${S}_{C}^{4}$$

of the construction skill ‘rebar worker’ of worker C is 7.

Further, in some embodiments, the skill quantification module 220 may correct the quantitative parameters of the construction skill of the worker based on the evaluation parameters of the construction skill of the worker. For example, the skill quantification module 220 may perform weighted summation on the evaluation parameters and the quantitative parameters of the corresponding construction skills of the worker based on preset evaluation correction weights of construction skills, so as to obtain the corrected quantitative parameters of the construction skills of the worker.

The preset evaluation correction weights of construction skills may include a cooperation weight, a satisfaction weight, and a quantification weight, and the sum of the cooperation weight, the satisfaction weight, and the quantification weight may be 1. In some embodiments, the preset evaluation correction weights of construction skills may be determined based on a user's input. For example, the evaluation correction weights of the construction skill ‘excavator operator’ may be determined based on the user's input as: a cooperation weight of 0.3, a satisfaction weight of 0.2, and a quantification weight of 0.5. In some embodiments, the preset evaluation correction weights of construction skills may be determined based on the richness degree of evaluation information regarding the construction skills of the worker from the cooperation fellow workers and the richness degree of evaluation information regarding the construction skills of the worker from customers. For example, taking the cooperation weight as an example, if the ratio of the number of cooperation fellow workers who submitted a cooperation evaluation table for the construction skill ‘rebar worker’ of worker C to the total number of cooperation fellow workers is less than 1/3, then the corresponding cooperation weight is 0.1. If the ratio is greater than or equal to 1/3 and less than 1/2, then the corresponding cooperation weight is 0.2. If the ratio is greater than or equal to 1/2, then the corresponding cooperation weight is 0.3.

For example, based on the cooperation weight of 0.3, the satisfaction weight of 0.2, and the quantification weight of 0.5, the quantitative parameters ‘quality parameter

$${Q}_{C}^{′1} ’$$

and ‘capacity parameter

$${N}_{C}^{′1} ’$$

of the construction skill ‘excavator operator’ of worker C are corrected, so as to obtain the corrected quality parameter

$${Q}_{C}^{″1} = 0.2 {D}_{C}^{1} + 0.3 {S}_{C}^{1} + 0.5 {N}_{C}^{′1} .$$

and the capacity parameter

$${N}_{C}^{″1} = 0.2 {D}_{C}^{1} + 0.3 {S}_{C}^{1} + 0.5 {N}_{C}^{′1} .$$

In some embodiments of the present disclosure, correcting the quantitative parameters of the construction skills of the worker based on the evaluation parameters of the construction skills of the worker may enable the corrected quantitative parameters to reflect the subjective feelings of the cooperation fellow workers and the customers of the worker regarding the construction skills of the worker. Thereby, the corrected quantitative parameters can evaluate the construction skills of the worker from the dimensions of cooperation awareness and service awareness of the worker, and improve the evaluation dimensions of the quantitative parameters.

It can be understood that the quantitative parameters of the construction skills can have timeliness. For example, as the construction experience of the worker C increases, the construction skill improves. For example, due to slackness, the construction skill of the worker A decreases. Therefore, in order to further consider the timeliness of the evaluation of the construction skills, the skill quantification module 220 can further correct the quantitative parameters of the construction skills of the workers.

In some embodiments, the skill quantification module 220 may obtain the at least one quantitative parameter of the at least one construction skill corresponding to the at least one time period, wherein the time period refers to a period of at least one time length from a current time, and the time length may be one month, two months, three months, 45 days, or the like. For example, assuming that the current time is t and the time length is T, the five time periods can include T1=[t−T, t], T2=[t−2T, t−T], T3=[t−3T, t−2T], T4=[t−4T, t−3T], and T5=[t−5T, t−4T]. The skill quantification module 220 may obtain the quantitative parameters

$${[ {F}_{C}^{′1} , {Q}_{C}^{′1} , {N}_{C}^{′1} ]}^{T 1} , {[ {F}_{C}^{′1} , {Q}_{C}^{′1} , {N}_{C}^{′1} ]}^{T 2} , {[ {F}_{C}^{′1} , {Q}_{C}^{′1} , {N}_{C}^{′ 1} ]}^{T 3} , {[ {F}_{C}^{′1} , {Q}_{C}^{′1} , {N}_{C}^{′1} ]}^{T 4} , and \\ {[ {F}_{C}^{′1} , {Q}_{C}^{′1} , {N}_{C}^{′1} ]}^{T 5}$$

of the construction skill ‘excavator operator’ of the worker A corresponding to the five time periods.

In some embodiments, the skill quantification module 220 may determine the at least one time weight corresponding to the at least one time period. In some embodiments, the closer the time period is to the current time, the greater the corresponding time weight is. For example, the corresponding time weights of the time periods T1, T2, T3, T4, and T5 can be 5, 4, 3, 2, and 1, respectively. In some embodiments, the sum of the at least one time weight may be 1. For example, the time weights corresponding to the five time periods are normalized to obtain the corresponding time weights of 5/(5+4+3+2+1)=0.33, 4/(5+4+3+2+1)=0.27, 3/(5+4+3+2+1)=0.2, 2/(5+4+3+2+1)=0.13, and 1/(5+4+3+2+1)=0.07.

In some embodiments, the skill quantification module 220 may determine the quantitative parameters of the construction skills based on the at least one quantitative parameter of the at least one construction skill corresponding to the at least one time period and the at least one time weight corresponding thereto. Continuing with the above example, the quantitative parameter of the construction skill ‘excavator operator’ of the worker A may be determined as follows:

$$[ {F}_{C}^{′′′1} , {Q}_{C}^{′′′1} , {N}_{C}^{′′′1} ] = {0.33 [ {F}_{C}^{′1} , {Q}_{C}^{′ 1} , {N}_{C}^{′1} ]}^{T 1} + {0.27 [ {F}_{C}^{′1} , {Q}_{C}^{′1} , {N}_{C}^{′1} ]}^{T 2} + 0 . {2 [ {F}_{C}^{′1} , {Q}_{C}^{′1} , {N}_{C}^{′1} ]}^{T 3} + 0.1 {3 [ {F}_{C}^{′1} , {Q}_{C}^{′1} , {N}_{C}^{′1} ]}^{T 4} + 0.0 {7 [ {F}_{C}^{′1} , {Q}_{C}^{′1} , {N}_{C}^{′1} ]}^{T 5} .$$

In some embodiments of the present disclosure, correcting the quantitative parameters of the construction skills based on the time weights corresponding to the time periods further considers the timeliness problem of the quantitative parameters, thereby being able to dynamically adjust the quantitative parameters of the workers, to more accurately reflect the current construction skills of the workers, and to better achieve a matching between the construction skills of the workers and the requirements of the construction tasks.

FIG. 5 is a flowchart illustrating the exemplary process for dispatching construction tasks to the workers in the construction organization according to some embodiments of the present disclosure. In some embodiments, the process 500 may be performed by the processing apparatus 110 or the intelligent dispatching system 200 (e.g., the task assignment module 240). For example, the process 500 may be stored in a storage apparatus in a form of programs or instructions. When the processing apparatus 110 or the intelligent dispatching system 200 (e.g., the task assignment module 240) executes the instructions, the process 500 may be realized. The schematic diagram of the operations of the process 500 presented below is illustrative. In some embodiments, the process may be completed by utilizing one or more additional operations not described and/or one or more operations not discussed. Further, the order of the operations of the process 500 shown in FIG. 5 and described below is not limiting.

In 510, obtaining the dispatching mode.

The dispatching mode refers to a manner of arranging workers to perform construction tasks based on the dispatching purpose. In some embodiments, the dispatching purpose includes but is not limited to a minimum cost, a shortest construction period, and consideration for both cost and construction period. In some embodiments, the dispatching mode includes but is not limited to a first dispatching mode, a second dispatching mode, and a third dispatching mode. The first dispatching mode refers to a dispatching mode for a dispatching purpose of a minimum cost. The second dispatching mode refers to a dispatching mode for a dispatching purpose of a shortest construction period. The third dispatching mode refers to a dispatching mode for a dispatching purpose of consideration for both cost and construction period. In some embodiments of the present disclosure, corresponding dispatching modes may also be determined based on other dispatching purposes, which is not limited in the embodiment.

In some embodiments, the task assignment module 240 may obtain the dispatching mode input by the user from the terminal device 120. In some embodiments, the task assignment module 240 may obtain the dispatching purpose input by the user from the terminal device 120 and determine the corresponding dispatching mode based on the dispatching purpose.

In 520, dispatching construction tasks to the workers in the construction organization based on the dispatching mode and the at least one first set.

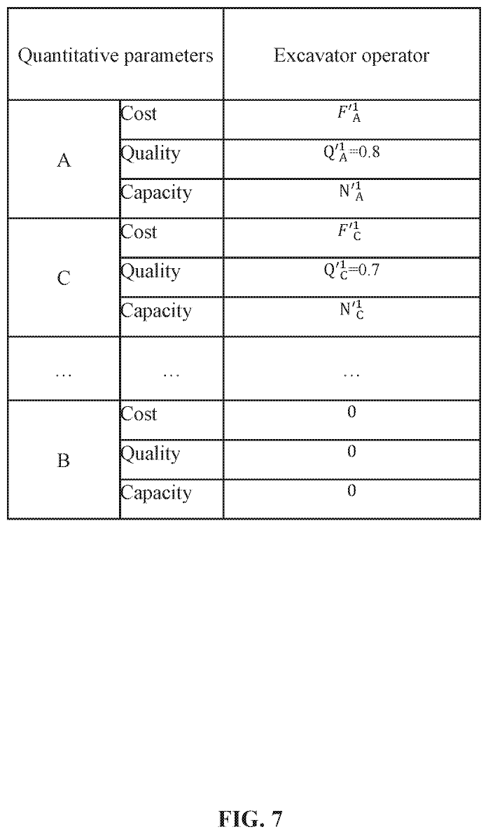

FIG. 8 is a schematic diagram illustrating an exemplary first dispatching mode according to some embodiments of the present disclosure. As shown in FIG. 8, the task assignment module 240 may dispatch construction tasks to the workers in the construction organization based on the first dispatching mode and the at least one first set.

Specifically, the task assignment module 240 determines the at least one combination cost parameter corresponding to the at least one first set based on the cost parameters of the workers in each of the initial worker combinations. The combination cost parameter refers to a sum of the cost parameters of the construction skills of all the workers in the corresponding first set. For example, for the ‘excavator operator’ corresponding to five workers in the worker sequence included in the first set M1, the corresponding combination cost parameter

$${F}_{M 1}^{′1}$$

is the sum of the cost parameters of the five workers. As shown in FIG. 8, the task assignment module 240 may obtain the 200 combination cost parameters

$${F}_{M 1}^{′ 1} , {F}_{M 2}^{′ 1} , {F}_{M 3}^{′ 1} , … , {F}_{M 200}^{′ 1}$$

corresponding to the 200 first sets M1, M2, M3, . . . , M200, respectively, wherein these first sets correspond to the target construction period of ‘one month’.

Further, the task assignment module 240 may determine the minimum combination cost parameter among the at least one combination cost parameter corresponding to the at least one first set, designate the first set corresponding to the minimum combination cost parameter as the second set, and dispatch construction tasks to the workers in the second set. As shown in FIG. 8, the minimum combination cost parameter

$${F}_{Mmim}^{′ 1} = {F}_{M 3}^{′ 1}$$

may be determined among the 200 combination cost parameters corresponding to the 200 first sets. The first set M3 corresponding to

$${F}_{M 3}^{′1}$$

is designated as the second set, and construction tasks are dispatched to the workers in the second set M3. In some embodiments of the present disclosure, when the target construction period is fixed, determining the second set based on the combination cost parameters corresponding to the first sets can efficiently determine the first dispatching mode.

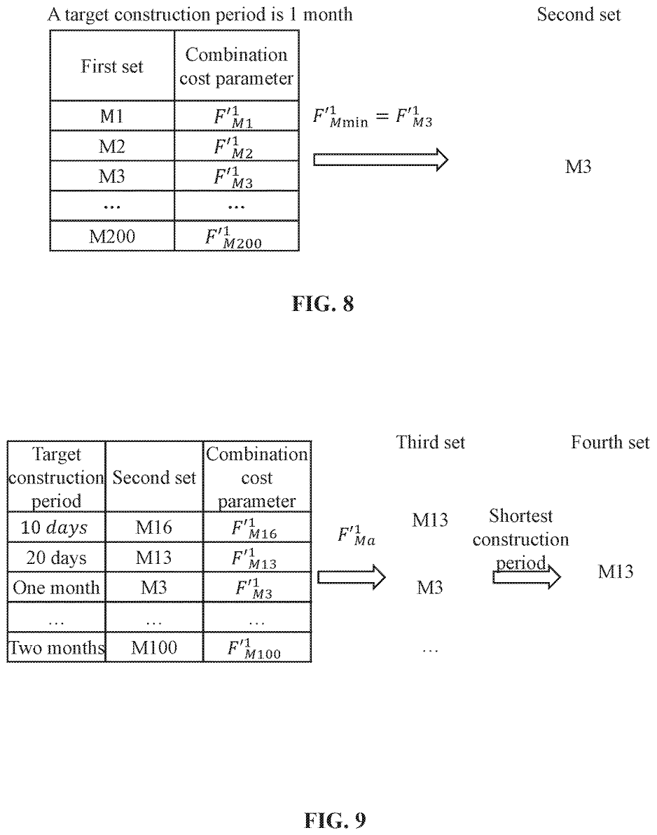

FIG. 9 is a schematic diagram illustrating an exemplary second dispatching mode according to some embodiments of the present disclosure. As shown in FIG. 9, the task assignment module 240 may dispatch construction tasks to the workers in the construction organization based on the second dispatching mode and the at least one first set.

Specifically, the task assignment module 240 may adjust the target construction period a plurality of times to obtain the plurality of second sets corresponding to the plurality of target construction periods. As shown in FIG. 9, the task assignment module 240 may adjust the target construction period to 10 days, 20 days, one month, . . . , and two months, respectively, to obtain the corresponding second sets M16, M13, M3, . . . , and M100. More descriptions for obtaining the second sets may be found in FIG. 8 and related descriptions thereof.

Further, the task assignment module 240 may determine the cost standard value based on the plurality of second sets, and determine the at least one third set from the plurality of second sets based on the cost standard value. For example, the cost standard value may be an average value of the combination cost parameters corresponding to the plurality of second sets. For example, as shown in FIG. 8, the cost standard value

$${F}_{Ma}^{′1}$$

may be an average value of

$${F}_{M 16}^{′ 1} , {F}_{M 13}^{′1} , {F}_{M 3}^{′ 1} , … , and {F}_{M 100}^{′ 1} .$$

The cost standard value may also be set as a median, a top ⅓ value, or the like, of the combination cost parameters corresponding to the plurality of second sets, and the present embodiment is not limited thereto. In some embodiments, the task assignment module 240 determines the second sets corresponding to the combination cost parameters not exceeding the cost standard value as the at least one third set. For example, as shown in FIG. 8, assuming that the combination cost parameters

$${F}_{M 13}^{′ 1} , {F}_{M 3}^{′ 1} , …$$

do not exceed the cost standard value

$${F}_{M a}^{′1} ,$$

then the second sets M13, M3, . . . corresponding to the combination cost parameters

$${F}_{M 13}^{′ 1} , {F}_{M 3}^{′ 1} , …$$

are determined as the third sets.

Still further, the task assignment module 240 determines the shortest target construction period among the at least one target construction period corresponding to the at least one third set, designates the third set corresponding to the shortest target construction period as the fourth set, and dispatches construction tasks to the workers in the fourth set. As shown in FIG. 8, assuming that the shortest target construction period among the target construction periods corresponding to the third sets M13, M3, . . . is 20 days, then the third set M13 corresponding to 20 days may be determined as the fourth set, and construction tasks are dispatched to the workers in the fourth set M13.

In some embodiments of the present disclosure, by adjusting the target construction period a plurality of times to obtain the plurality of second sets, determining the at least one third set based on the cost standard value, and further obtaining the fourth set based on the target construction period corresponding to the third sets, the second dispatching mode can ensure that the corresponding fourth set with the shortest construction period is determined within a lower cost range.

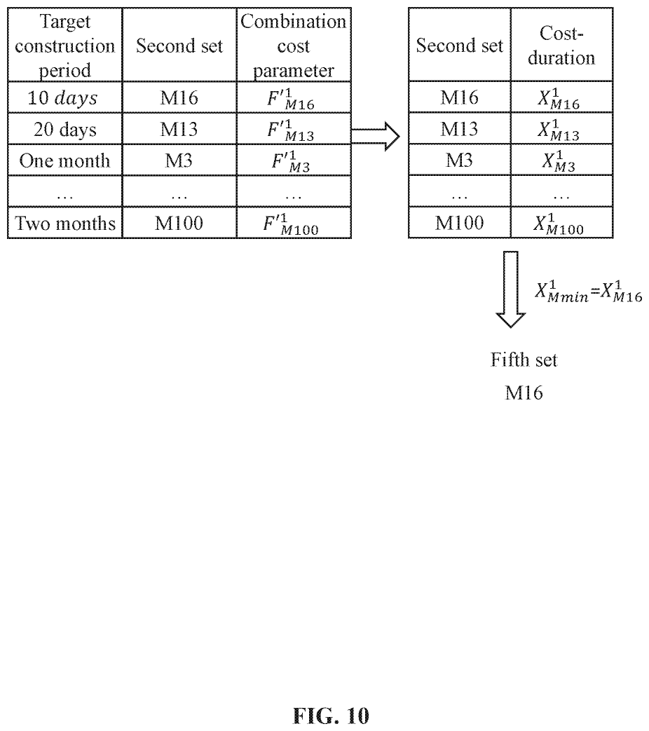

FIG. 10 is a schematic diagram illustrating an exemplary third dispatching mode according to some embodiments of the present disclosure. As shown in FIG. 10, the task assignment module 240 may dispatch construction tasks to the workers in the construction organization based on the third dispatching mode and the at least one first set.

Specifically, the task assignment module 240 may adjust the target construction period a plurality of times to obtain a plurality of second sets corresponding to a plurality of target construction periods. More descriptions of the plurality of second sets corresponding to the plurality of target construction periods may be found in FIG. 9 and its related descriptions.

Further, the task assignment module 240 may determine a cost-duration coefficient corresponding to each second set based on the combination cost parameter and the target construction period corresponding to each second set. The cost-duration coefficient is a comprehensive coefficient for evaluating the importance of the construction period and the cost corresponding to the second set in the current construction project. For example, the cost-duration coefficient can be the sum of squares of the combination cost parameter and the target construction period corresponding to the second set. Further, for example, the cost-duration coefficient may also be the sum or a weighted value of the combination cost parameter and the target construction period corresponding to the second set, which is not limited in the embodiment. As shown in FIG. 10, the task assignment module 240 can use the cost-duration coefficients

$${X}_{M 16}^{1} , {X}_{M 13}^{1} , {X}_{M 3}^{1} , … , {X}_{M 100}^{1}$$

corresponding to the second sets M16, M13, M3, . . . , M100.

Even further, the task assignment module 240 may sort the plurality of second sets according to the cost-duration coefficient, determine a fifth set based on the sorting result, and dispatch construction tasks to the workers in the fifth set. Merely as an example, as shown in FIG. 10, the task assignment module 240 may sort the second sets M16, M13, M3, . . . , M100 according to the cost-duration coefficients

$${X}_{M 16}^{1} , {X}_{M 13}^{1} , {X}_{M 3}^{1} , … , {X}_{M 100}^{1} ,$$

determine the minimum value of the cost-duration coefficient

$${X}_{Mmin}^{1} = {X}_{M 16}^{1}$$

based on the sorting result, designate the second set M16 corresponding to the minimum value of the cost-duration coefficient as the fifth set, and dispatch the construction tasks to the workers in the fifth set M16. The present disclosure may also determine the fifth set from the sorting result by adopting a corresponding manner based on different manners of determining the cost-duration coefficient, which is not limited in the embodiment.

In some embodiments of the present disclosure, by determining the fifth set based on the cost-duration coefficient, the third dispatching mode can comprehensively consider the cost and construction period factors.

In some embodiments of the present disclosure, according to different dispatching modes determined by the user, by determining the corresponding optimal mode based on the first set, different requirements of different construction tasks can be satisfied.

In some embodiments, the task assignment module 240 may determine the at least one target worker from the one or more workers based on the dispatching mode and the at least one first set.

In some embodiments, the task assignment module 240 may determine the at least one target worker from one or more workers based on the first dispatching mode and the at least one first set. Specifically, the task assignment module 240 may determine at least one combination cost parameter corresponding to the at least one first set based on the cost parameters of the workers in each initial worker combination; determine a minimum combination cost parameter among the at least one combination cost parameter corresponding to the at least one first set, designate the first set corresponding to the minimum combination cost parameter as a second set, and determine the at least one target worker based on the second set. For example, the target worker may be determined from the workers in the second set M3.

In some embodiments, the task assignment module 240 may determine the at least one target worker from one or more workers based on the second dispatching mode and the at least one first set. Specifically, the task assignment module 240 may adjust the target construction period a plurality of times to obtain a plurality of second sets corresponding to a plurality of target construction periods; determine a cost standard value based on the plurality of second sets, and determine at least one third set from the plurality of second sets based on the cost standard value; determine a shortest target construction period among the at least one target construction period corresponding to the at least one third set, designate the third set corresponding to the shortest target construction period as a fourth set, and determine the at least one target worker based on the fourth set. For example, the target worker may be determined from the workers in the fourth set M13.

In some embodiments, the task assignment module 240 may determine the at least one target worker from one or more workers based on the third dispatching mode and the at least one first set. Specifically, the task assignment module 240 may adjust the target construction period a plurality of times to obtain a plurality of second sets corresponding to a plurality of target construction periods; determine a cost-duration coefficient corresponding to each second set based on the combination cost parameter and the target construction period corresponding to each second set; sort the plurality of second sets according to the cost-duration coefficient, determine a fifth set based on the sorting result, and determine the at least one target worker based on the fifth set. For example, the target worker may be determined from the workers in the fifth set M16.

FIG. 11 is a flowchart illustrating an exemplary process for updating the quantitative parameters of construction skills according to some embodiments of the present disclosure. In some embodiments, the process 1100 may be performed by the processing device 110 or the intelligent dispatching system 200 (e.g., the update module 250). For example, the process 1100 may be stored in a storage device in the form of a program or instructions, and when the processing device 110 or the intelligent dispatching system 200 (e.g., the update module 250) executes the instructions, the process 1100 may be implemented. The operations of the process 1100 presented below are illustrative. In some embodiments, the process may be completed by utilizing one or more additional operations not described and/or one or more operations not discussed. In addition, the order for the operations of process 1100 shown in FIG. 11 and described below is not limiting.

In 1110, periodically receiving a target task schedule transmitted by a target terminal.

The target task schedule is a table for tracking the construction task arrangement of the target worker. In some embodiments, the target task schedule is generated by the target worker terminal 120 based on the construction tasks in progress and the currently received construction tasks of the target worker, and updated by the target worker terminal based on the completion status of the construction tasks in progress and the currently received construction tasks submitted by the target worker. For example, the target worker inputs construction task information in progress through the worker terminal 120 (e.g., ‘wall masonry’, with a total workload of 100 m², current progress of 40%, and planned completion time of 3 days). When receiving a new construction task (e.g., ‘wall plastering’, with a total workload of 80 m², and planned completion time of 2 days), the worker terminal 120 automatically integrates the two pieces of task information to generate the target task schedule. When the target worker completes 50 m² of wall masonry, the target worker submits the completion status through the worker terminal 120. The worker terminal 120 updates the progress of the wall masonry to 50% and simultaneously updates the target task schedule.

Periodically refers to a preset time interval, such as 12 h. The update module 260 receives a target task schedule from one or more target terminals of one or more target workers based on the preset time interval.

In 1120, determining a construction task status of the target worker based on a target task schedule.

The construction task status is information regarding the execution progress of construction tasks by the target worker. For example, the construction task status includes unfinished and completed. The ‘completed’ refers to the target worker completing the execution of the construction task, and simultaneously obtaining the evaluation parameters corresponding to the construction task. More descriptions of the evaluation parameters may be found in the related descriptions of operation 430, which may not be repeated herein.

In 1130, updating the historical construction task information upon detecting a change in the construction task status of any worker.

The change in the construction task status refers to a change from ‘unfinished’ to ‘completed’. When a construction task in execution changes to a historical construction task, the update module 260 may update the historical construction task information based on the newly added historical construction task. The process of updating the historical construction task information is similar to the process of obtaining the historical construction task information in Step 320, which may not be repeated herein.

In 1140, updating the quantitative parameters of construction skills based on the updated historical construction task information. The process of updating the quantitative parameters of construction skills based on the updated historical construction task information is similar to the process of determining the corresponding quantitative parameters of construction skills based on the historical construction task information in the operation 330, which may not be repeated herein.

Beneficial effects that may be brought by embodiments of the present disclosure include but are not limited to: (1) by establishing the mapping relationship between construction skills and construction tasks, and quantifying the construction skills of the workers from a plurality of dimensions such as capacity, cost, and quality, thereby dispatching construction tasks to the workers in the construction organization based on the mapping relationship, according to the construction task to be assigned and the quantified construction skills (i.e., the quantitative parameters), the dispatching efficiency can be improved while simultaneously considering the construction period, cost, and quality requirements of construction tasks; (2) by quantifying the evaluated construction skills of the workers, and converting the quantified absolute indicators into relative indicators based on the industry benchmark, the relative indicator ‘quantitative parameters’ can more intuitively reflect the level of the construction skills of the workers relative to the overall industry level, either high or low; (3) by correcting the quantitative parameters of the construction skills of the workers based on the evaluation parameters of the construction skills of the workers, the corrected quantitative parameters can reflect the subjective feelings of the cooperating peers and customers of the workers towards the construction skills of the workers, thereby enabling the corrected quantitative parameters to evaluate the construction skills of the workers from the dimensions of cooperation awareness and service awareness of the workers, and improving the evaluation dimension of the quantitative parameters; (4) by correcting the quantitative parameters of construction skills based on a time coefficient corresponding to a time period, the timeliness issue of the quantitative parameters is further considered, thereby allowing dynamic adjustment of the quantitative parameters of the workers, more accurately reflecting the current construction skills of the workers, and better achieving the matching of the construction skills of the workers with the requirements of construction tasks; (5) by determining the selected workers from the initial workers based on the preset qualification condition and the target construction period corresponding to the construction task to be assigned, workers who do not meet the qualification requirements or do not have a suitable schedule can be pre-screened out, thereby improving the efficiency of subsequent dispatching; (6) by obtaining a worker sequence according to the quality parameters of the target construction skill of the selected workers, it can be ensured that the selected workers better meet construction task requirements and simultaneously guarantee construction quality of construction tasks, avoiding dispatching workers who are not proficient in corresponding construction skills to unsuitable construction tasks; (7) by determining at least one first set from at least one initial worker combination based on the target capacity, it can be ensured that construction tasks are completed according to the target construction period; (8) by determining the corresponding optimal mode based on the first set according to different dispatching modes determined by a user, different requirements of different construction tasks can be satisfied: for example, when the target construction period is fixed, by determining a second set based on the combination cost parameter corresponding to the first set, the first dispatching mode can be efficiently determined; further for example, by adjusting the target construction period a plurality of times to obtain a plurality of second sets, determining at least one third set based on a cost standard value from the plurality of second sets, and then obtaining a fourth set based on the target construction periods corresponding to the third set, it can be ensured that the second dispatching mode can determine the corresponding shortest construction period for the fourth set within a lower cost range; further for example, by determining a fifth set based on the cost-duration coefficient, the third dispatching mode can comprehensively consider the cost and construction period factors.

Basic concepts have been described above. Obviously, for a person skilled in the art, the detailed disclosure above serves merely as an example, and does not constitute a limitation on the present disclosure. Although not explicitly stated herein, a person skilled in the art may make various modifications, improvements, and amendments to the present disclosure. Such modifications, improvements, and amendments are contemplated by the present disclosure, thus, such modifications, improvements, and amendments are still within the spirit and scope of the exemplary embodiments of the present disclosure.

Additionally, the present disclosure uses specific words to describe the embodiments of the present disclosure. Such as ‘an embodiment’, ‘one embodiment’, and/or ‘some embodiments’ mean a certain feature, structure, or characteristic related to at least one embodiment of the present disclosure. Therefore, it should be emphasized and noted that ‘one embodiment’ or ‘an embodiment’ or ‘an alternative embodiment’ mentioned twice or a plurality of times at different locations in the present disclosure does not necessarily refer to the same embodiment. Furthermore, certain features, structures, or characteristics in one or more embodiments of the present disclosure can be suitably combined.

In addition, unless explicitly stated in the claims, the order of processing elements and sequences, the use of alphanumeric characters, or the use of other names described in the present disclosure is not intended to limit the order of processes and methods of the present disclosure. Although some currently useful inventive embodiments have been discussed through various examples in the above disclosure, it should be understood that such details serve merely for illustrative purposes, the appended claims are not limited to the disclosed embodiments. On the contrary, the claims are intended to cover all modifications and equivalent combinations falling within the spirit and scope of the embodiments of the present disclosure. For example, although the system components described above can be implemented by hardware devices, they can also be implemented only through software solutions, such as installing the described system on an existing server or mobile device.

Similarly, it should be noted that to simplify the description of the present disclosure, and thereby facilitate understanding of one or more inventive embodiments, in the foregoing description of the embodiments of the present disclosure, sometimes a plurality of features are grouped into a single embodiment, a figure, or a description thereof. However, this manner of disclosure does not mean that the object of the present disclosure requires more features than those recited in the claims. Indeed, the features of an embodiment may be fewer than all the features of a single embodiment disclosed above.

In some embodiments, numbers describing component quantities and attribute quantities are used. It should be understood that such numbers used in the description of the embodiments are, in some examples, modified by the modifiers ‘approximately’, ‘about’, or ‘substantially’. Unless otherwise stated, ‘approximately’, ‘about’, or ‘substantially’ indicates that the stated numbers allow for a variation of +20%. Accordingly, in some embodiments, the numerical parameters used in the description and the claims are all approximate values, and the approximate values can be changed according to the characteristics required by individual embodiments. In some embodiments, the numerical parameters should consider the specified significant digits and adopt a general method of retaining digits. Although numerical domains and parameters used in some embodiments of the present disclosure to confirm their breadth of scope are approximate values, in specific embodiments, the setting of such numerical values is as precise as possible within the feasible range.

For each patent, patent application, patent application publication, and other materials cited in the present disclosure, such as articles, books, manuals, publications, documents, and so on, the entire contents of which are hereby incorporated by reference into the present disclosure. Except for application history documents inconsistent with or conflicting with the content of the present disclosure, and also except for documents that limit the broadest scope of the claims of the present disclosure (currently or later appended to the present disclosure). It should be noted that if the descriptions, definitions, and/or use of terms in the ancillary materials of the present disclosure are inconsistent with or conflict with the content described in the present disclosure, the descriptions, definitions, and/or use of terms in the present disclosure shall prevail.

Finally, it should be understood that the embodiments described in the present disclosure are merely for illustrating the principles of the embodiments of the present disclosure. Other variations may also fall within the scope of the present disclosure. Thus, as an example and not a limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. An intelligent dispatching method, wherein the intelligent dispatching method is performed by an intelligent dispatching system, wherein the intelligent dispatching system is deployed on a construction management server, and the method comprises:
obtaining a mapping relationship between construction tasks and construction skills from the construction management server; wherein the mapping relationship between the construction tasks and the construction skills is established by an administrator terminal and uploaded to the construction management server;
obtaining historical construction task information of one or more workers in a construction organization from the construction management server, and obtaining the construction skills of the one or more workers from one or more worker terminals of the one or more workers;
determining quantitative parameters of the construction skills corresponding to the historical construction task information, wherein the quantitative parameters of the construction skills at least include a cost parameter, a quality parameter, and a capacity parameter;
obtaining a construction task to be assigned in a construction project from the construction management server, and determining at least one target worker from the one or more workers based on the mapping relationship according to the construction task to be assigned and the quantitative parameters of the construction skills; and
dispatching the construction task to be assigned to at least one target worker terminal of the at least one target worker.

2. The method according to claim 1, wherein the determining quantitative parameters of the construction skills corresponding to the historical construction task information includes:
obtaining a standard skill factor of a construction skill, wherein the standard skill factor is configured to quantify an industry benchmark of the construction skill;
determining a personal skill factor of each of the one or more workers according to the historical construction task information of the one or more workers; and
determining quantitative parameters of the construction skill of the one or more workers based on the standard skill factor and the personal skill factor of each of the one or more workers.

3. The method according to claim 2, wherein the determining quantitative parameters of the construction skill of the one or more workers based on the standard skill factor and the personal skill factor of each of the one or more workers includes:
obtaining evaluation parameters of the construction skill of the one or more workers according to the historical construction task information of the one or more workers, wherein the evaluation parameters at least include a cooperation intention parameter and a customer satisfaction parameter; and
correcting the quantitative parameters of the construction skill of the one or more workers based on the evaluation parameters of the construction skill of the one or more workers.

4. The method according to claim 1, wherein the determining the quantitative parameters of the construction skills corresponding to the historical construction task information includes:
obtaining at least one quantitative parameter of at least one construction skill corresponding to at least one time period;
determining at least one time weight corresponding to the at least one time period; and
determining the quantitative parameters of the construction skills based on the at least one quantitative parameter of the at least one construction skill corresponding to the at least one time period and the at least one time weight corresponding to the at least one time period.

5. The method according to claim 1, wherein the determining at least one target worker from the one or more workers based on the mapping relationship according to the construction task to be assigned and the quantitative parameters of the construction skills includes:
screening initial workers from the construction organization according to a preset qualification condition;
determining a target construction period corresponding to the construction task to be assigned;
determining selected workers from the initial workers based on the target construction period; and
determining the at least one target worker from the selected workers.

6. The method according to claim 5, wherein the determining the at least one target worker from the selected workers includes:
determining a target construction skill corresponding to the construction task to be assigned based on the mapping relationship;
sorting the selected workers according to quality parameters of the target construction skill of each of the selected workers to obtain a worker sequence; and
determining the at least one target worker based on the worker sequence.

7. The method according to claim 6, wherein the determining the at least one target worker based on the worker sequence includes:
determining at least one initial worker combination from the worker sequence;
determining at least one combination capacity factor corresponding to the at least one initial worker combination based on a personal capacity skill factor of each worker in each of the at least one initial worker combination;
determining a target capacity corresponding to the target construction period and a target workload of the construction task to be assigned;
determining at least one first set from the at least one initial worker combination based on the target capacity and the at least one combination capacity factor, wherein the combination capacity factor corresponding to the first set satisfies the target capacity; and
determining the at least one target worker based on the at least one first set.

8. The method according to claim 7, wherein the determining the at least one target worker based on the at least one first set includes:
obtaining a dispatching mode;
determining the at least one target worker from the one or more workers based on the dispatching mode and the at least one first set.

9. The method according to claim 8, wherein the dispatching mode includes a first dispatching mode; and the determining the at least one target worker from the one or more workers based on the dispatching mode and the at least one first set includes:
determining at least one combination cost parameter corresponding to the at least one first set based on cost parameters of each of the one or more workers in each of the initial worker combinations; and
determining a minimum combination cost parameter among the at least one combination cost parameter corresponding to the at least one first set, designating the first set corresponding to the minimum combination cost parameter as a second set, and determining the at least one target worker based on the second set.

10. The method according to claim 9, wherein the dispatching mode includes a second dispatching mode; and the determining the at least one target worker from the one or more workers based on the dispatching mode and the at least one first set includes:
adjusting the target construction period multiple times to obtain a plurality of second sets corresponding to a plurality of target construction periods;
determining a cost standard value based on the plurality of second sets, and determining at least one third set from the plurality of second sets based on the cost standard value; and
determining a shortest target construction period among the at least one target construction period corresponding to the at least one third set, designating the third set corresponding to the shortest target construction period as a fourth set, and determining the at least one target worker based on the fourth set.

11. The method according to claim 9, wherein the dispatching mode includes a third dispatching mode; and the determining the at least one target worker from the one or more workers based on the dispatching mode and the at least one first set includes:
adjusting the target construction period multiple times to obtain a plurality of second sets corresponding to a plurality of target construction periods;
determining a cost-duration coefficient corresponding to each second set based on the combination cost parameter and the target construction period corresponding to each second set; and
sorting the plurality of second sets according to the cost-duration coefficient, determining a fifth set based on a sorting result, and determining the at least one target worker based on the fifth set.

12. The method of claim 1, wherein the method further includes:
periodically receiving a target task schedule sent by a target terminal, wherein the target task schedule is generated by the at least one target worker terminal based on construction tasks in progress of the at least one target worker and currently received construction tasks and is updated by the at least one target worker terminal based on a completion status of the construction tasks in progress and the currently received construction tasks submitted by the at least one target worker;
determining a construction task status of the at least one target worker based on the target task schedule;
updating the historical construction task information when a change in the construction task status of any worker is detected; and
updating the quantitative parameters of the construction skills based on the updated historical construction task information.

13. An intelligent dispatching system, wherein the intelligent dispatching system is deployed on a construction management server, the system comprising:
a relationship establishing module, configured to obtain a mapping relationship between construction tasks and construction skills from the construction management server; wherein the mapping relationship between the construction tasks and the construction skills is established by an administrator terminal and uploaded to the construction management server;
a skill quantification module, configured to:
obtain historical construction task information of one or more workers in a construction organization from the construction management server, and obtain the construction skills of the one or more workers from one or more worker terminals of the one or more workers and determine quantitative parameters of the construction skills corresponding to the historical construction task information, wherein the quantitative parameters of the construction skills at least include a cost parameter, a quality parameter, and a capacity parameter;
a task obtaining module, configured to obtain a construction task to be assigned in a construction project from the construction management server; and
a task assignment module, configured to determine at least one target worker from the one or more workers based on the mapping relationship according to the construction task to be assigned and the quantitative parameters of the construction skills and dispatch the construction task to be assigned to at least one target worker terminal of the at least one target worker.

14. A non-transitory computer-readable storage medium, wherein the storage medium stores computer instructions, and when a computer reads the computer instructions in the storage medium, the computer performs the intelligent dispatching method according to claim 1.
